(19) United States
(12) Patent Application Publication
(10) Pub. No.: US 2025/0055378 A1
(43) Pub. Date: Feb. 13, 2025

(54) SYSTEMS AND METHODS FOR DC-DC POWER CONVERTER TOPOLOGIES

(71) Applicant: McMaster University, Hamilton (CA)

(72) Inventors: Ahmed Elezab, Hamilton (CA); Omar Zayed, Hamilton (CA); Mehdi Narimani, Oakville (CA)

(21) Appl. No.: 18/231,887

(22) Filed: Aug. 9, 2023

(51) Int. Cl. H02M 3/335; H02M 3/00

(52) U.S. Cl. CPC H02M 3/33573; H02M 3/01; H02M 3/33576

(57) ABSTRACT

Systems and methods for providing DC-DC power converter topologies are described. In at least one embodiment, a DC-DC power converter comprises a primary sub-circuit coupled to a fixed or variable DC input voltage, a first secondary sub-circuit and a second secondary sub-circuit, a transformer isolating the primary sub-circuit from the first and the second secondary sub-circuits, the transformer comprising a predetermined number of turns, the first and the second secondary sub-circuits being configurable in a series mode and a parallel mode by switching configurations of a first, second and third transition switch, and the first and the second secondary sub-circuits providing an output charging voltage and an output charging current for charging an external device.

### FIELD

The described embodiments generally relate to systems and methods for DC-DC power converter topologies.

### BACKGROUND

The transportation sector is a significant contributor to global greenhouse gas emission. Internal combustion engines of motor vehicles burn fossil fuels like gasoline and diesel to drive the vehicles and generate greenhouse gas emissions in the process. The greenhouse gas emission of the transportation sector can be reduced by using electric vehicles instead of internal combustion engine-based motor vehicles. However, despite the push to electrification, two significant challenges stand in the way of reducing the greenhouse gas emission of the transportation sector—availability of cost-effective electric vehicle service equipment (EVSE) and decarbonization of power generation. Increased use of direct current (DC)-connected charging stations may be the key to electrification and the wide adoption of electric vehicles. Accordingly, improvements to the DC-connected charging stations are needed.

### SUMMARY

The following summary is provided to introduce the reader to the more detailed discussion to follow. The summary is not intended to limit or define any claimed or as yet unclaimed invention. One or more inventions may reside in any combination or sub-combination of the elements or process steps disclosed in any part of this document including its claims and figures.

In a first aspect, in at least embodiment, there is provided a DC-DC power converter. The DC-DC power converter comprises: a primary sub-circuit coupled to a fixed or variable DC input voltage, a first secondary sub-circuit and a second secondary sub-circuit, a transformer isolating the primary sub-circuit from the first and the second secondary sub-circuits, the transformer comprising a predetermined number of turns, the first and the second secondary sub-circuits being configurable in a series mode and a parallel mode by switching configurations of a first, second and third transition switch, and the first and the second secondary sub-circuits providing an output charging voltage and an output charging current for charging an external device.

In some embodiments, the primary sub-circuit comprises a full-bridge switching circuit, a resonant inductor, and a resonant capacitor; and each of the first and second secondary sub-circuits comprise a full-bridge switching circuit.

In some embodiments, the primary sub-circuit comprises a 3-L neutral point clamped input voltage; and each of the first and second secondary sub-circuits comprise a full-bridge switching circuit and an inductor.

In various embodiments, the inductor is a shim inductor.

In various embodiments, the primary sub-circuit further comprises two flying capacitors.

In some embodiments, the primary sub-circuit comprises a 3-L neutral point clamped input voltage, a resonant inductor and a resonant capacitor; and each of the first and second secondary sub-circuits comprise a full-bridge diode rectifier circuit. In various embodiments, the primary sub-circuit further comprises two flying capacitors.

In some embodiments, the primary sub-circuit comprises a 3-L neutral point clamped input voltage, a resonant inductor and a resonant capacitor; and each of the first and second secondary sub-circuits comprise a full-bridge diode rectifier circuit.

In accordance with another aspect, in at least one embodiment, there is provided a DC-DC power converter. The DC-DC power converter comprises: a primary sub-circuit coupled to a DC input voltage, a secondary sub-circuit comprising a first secondary sub-circuit, a second secondary sub-circuit, and an inductor, the secondary sub-circuit providing an output charging voltage and an output charging current for charging an external device, and a transformer isolating the primary sub-circuit from the secondary sub-circuit, the transformer comprising a predetermined number of turns, wherein each of the first secondary sub-circuit and the second secondary sub-circuit comprises a 3-L inverter circuit.

In some embodiments, the inductor is a shim inductor.

In various embodiments, each of the first secondary sub-circuit and the second secondary sub-circuit further comprise a flying capacitor.

In accordance with a further aspect, in at least one embodiment, there is provided a DC-DC power converter. The DC-DC power converter comprises: a primary sub-circuit coupled to a DC input voltage, the primary sub-circuit comprising a 3-L neutral point clamped input voltage, a first primary sub-circuit, and a second primary sub-circuit, each of the first primary sub-circuit and the second primary sub-circuit comprising a 3-L inverter circuit, a secondary sub-circuit comprising a first secondary sub-circuit, a second secondary sub-circuit, and an inductor, the secondary sub-circuit providing an output charging voltage and an output charging current for charging an external device, and a transformer isolating the primary sub-circuit from the secondary sub-circuit, the transformer comprising a predetermined number of turns, wherein each of the first secondary sub-circuit and the second secondary sub-circuit comprises a 3-L inverter circuit.

In some embodiments, the inductor is a shim inductor.

In various embodiments, each of the first primary sub-circuit and the second primary sub-circuit further comprise a flying capacitor.

In various embodiments, each of the first secondary sub-circuit and the second secondary sub-circuit further comprise a flying capacitor.

In accordance with another aspect, in at least one embodiment, there is provided a DC-DC power converter. The DC-DC power converter comprises: a primary sub-circuit coupled to a DC input voltage, the primary sub-circuit comprising a 3-L neutral point clamped input voltage, a resonant inductor, a resonant capacitor, a first primary sub-circuit, and a second primary sub-circuit, each of the first primary sub-circuit and the second primary sub-circuit comprising a 3-L inverter circuit, a secondary sub-circuit comprising a first secondary sub-circuit, a second secondary sub-circuit, a resonant inductor and a resonant capacitor, the secondary sub-circuit providing an output charging voltage and an output charging current for charging an external device, and a transformer isolating the primary sub-circuit from the secondary sub-circuit, the transformer comprising a predetermined number of turns, wherein each of the first secondary sub-circuit and the second secondary sub-circuit comprises a 3-L inverter circuit.

In various embodiments, each of the first primary sub-circuit and the second primary sub-circuit further comprise a flying capacitor.

In various embodiments, each of the first secondary sub-circuit and the second secondary sub-circuit further comprise a flying capacitor.

In accordance with a further aspect, in at least one embodiment, there is provided a charging station. The charging station comprising at least one charging pole, each charging pole having one or more charging modules, each of the one or more charging modules comprising at least one DC-DC power converter according to the embodiments described herein, wherein one or more electric vehicles are charged based on the output charging voltage of the corresponding DC-DC power converter.

In various embodiments, the one or more DC-DC power converters of each charging pole are arranged in parallel to provide fast charging power to one or more electric vehicles.

In various embodiments, the one or more DC-DC power converter modules of each charging pole can cover a wide charging voltage range and can be connected in a parallel input-output configuration to accommodate a wide range of charging power needs of electric vehicles.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a schematic view of a DC-connected charging station in accordance with an embodiment.

FIG. 2 is a schematic diagram showing generalized structure for a charging module of the DC-connected charging station of FIG. 1.

FIG. 3 is a schematic diagram showing generalized sub-module structure of the charging module of FIG. 2.

FIG. 4 is a schematic diagram of a DC-DC power converter topology in accordance with an example embodiment.

FIG. 5 is a schematic diagram of a DC-DC power converter topology in accordance with another example embodiment.

FIG. 6 is a schematic diagram of a DC-DC power converter topology in accordance with a further example embodiment.

FIG. 7 is a schematic diagram of a DC-DC power converter topology in accordance with another example embodiment.

FIG. 8 is a schematic diagram of a DC-DC power converter topology in accordance with a further example embodiment.

FIG. 9 is a schematic diagram of a DC-DC power converter topology in accordance with an example embodiment.

FIG. 10 is a schematic diagram of a DC-DC power converter topology in accordance with another example embodiment.

FIG. 11 is a schematic diagram of a DC-DC power converter topology in accordance with a further example embodiment.

FIG. 12 is a schematic diagram of a DC-DC power converter topology in accordance with an example embodiment.

FIG. 13 is a schematic diagram of a DC-DC power converter topology in accordance with another example embodiment.

FIG. 14 is a schematic diagram of a DC-DC power converter topology in accordance with another example embodiment.

FIG. 15 is a schematic diagram of a DC-DC power converter topology in accordance with a further example embodiment.

FIG. 16 is a schematic diagram of a DC-DC power converter topology in accordance with another example embodiment.

FIG. 17 is a schematic diagram of a DC-DC power converter topology in accordance with a further example embodiment.

FIG. 18 is a schematic diagram of a DC-DC power converter topology in accordance with an example embodiment.

FIG. 19 is a schematic diagram of a DC-DC power converter topology in accordance with another example embodiment.

FIG. 20 is a schematic diagram of a DC-DC power converter topology in accordance with a further example embodiment.

FIG. 21 is a schematic diagram of a DC-DC power converter topology in accordance with another example embodiment.

### DETAILED DESCRIPTION

Numerous embodiments are described in this application and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

As used herein and in the claims, a group of elements are said to ‘collectively’ perform an act where that act is performed by any one of the elements in the group, or performed cooperatively by two or more (or all) elements in the group.

As used herein and in the claims, a first element is said to be “received” in a second element where at least a portion of the first element is received in the second element unless specifically stated otherwise.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112₁, 112₂, and 112₃). All elements with a common base number may be referred to collectively or generically using the base number without a suffix (e.g., 112).

There can be several barriers to the widespread adoption of electric vehicles (EVs). One such barrier is the lack of an ultra-fast and efficient EV charging solution. Another barrier is the lack of a cost-effective charging solution. DC-connected charging stations, in contrast to AC-connected charging stations, have been recognized to provide many advantages. For example, DC-connected charging stations can promote decarbonization by, for example, allowing the integration of renewable energy sources (RESs). DC-connected charging stations also tend to have fewer conversion stages compared to AC-connected stations, thereby reducing overall system cost by, for example, being smaller and more efficient.

However, conventional AC and DC-connected solutions still have some disadvantages. For example, such solutions generally: i) tend to be limited multi-stage AC-connected stations, ii) fall short in efficiently covering a wide output voltage range, iii) require high number of components and/or devices with high kVA rating, iv) tend to be non-isolated, thus contradicting current charging standards, and/or v) tend to be unidirectional, thereby preventing vehicle-to-grid (V2G) capability. In addition, most AC-connected solutions cannot be utilized for DC-connected stations since each front-end stage assists in regulating the output charging voltage. However, this cannot be realized in DC-connected stations due to a shared front-end. Accordingly, even with the use of AC and/or DC-connected charging stations, challenges remain with increasing the adaptability of the station so that it can accommodate the diverse charging needs of various vehicle types.

Described herein are multiple DC-DC power converter topologies that address some of the disadvantages associated with conventional AC and/or DC charging stations. The disclosed DC-DC power converter topologies can provide a wide output and input voltage range and meet different charging application targets including high-power charging, high efficiency, and cost effectiveness. The disclosed DC-DC power converter topologies provides advantages including a modular design and offer a wide input and output voltage range, all while maintaining an overall high efficiency and device utilization. In the various embodiments disclosed herein, the DC-DC converter provides the advantage of maintaining a high efficiency and performance throughout the charging duration and over a wide output voltage range, as opposed to only specific instants in time and/or at specific output voltage points.

In some embodiments, the DC-DC power converters disclosed herein are used in EV charging stations. In some other embodiments, the DC-DC power converters disclosed herein are used as on-board EV chargers. In some further embodiments, the DC-DC power converters disclosed herein are used for remote or off-grid charging applications. The DC-DC power converters disclosed herein can be used as a single module or in combination with other modules.

The wide charging voltage range provided by the disclosed DC-DC power converter topologies may be critical for future proofing stations to support existing and next generation EVs. In various embodiments, selection of the DC-DC power converter parameters may be based on an energy-based optimization strategy that considers the full range of charging scenarios of the DC-DC power converter. In some cases, the energy-based optimization can be based on data collected from actual EV charging sessions. In some other cases, the energy-based optimization can be based on data collected from simulations of EV charging sessions.

The disclosed DC-DC power converter topologies can enable charging poles of EV charging stations to efficiently cover a wider charging voltage range compared with conventional charging poles (e.g., approximately three times conventional charging poles). The disclosed DC-DC power converter topologies can provide high charging voltage capability enabling higher charging power and faster charging of plugged-in electric vehicles (PEVs) thereby reducing problems associated with long charging times and reducing range anxiety of drivers.

The disclosed DC-DC power converter topologies aim to support current and future charging standards for PEVs. The charging standards can be, for example, the multi-megawatt charging standard (MCS) with charging voltages up to 1500 V, the combined charging standard (CCS) with charging voltages up to 1000 V etc.

The disclosed DC-DC power converter topologies can be used in charging stations to provide an ultra-fast charging experience to numerous vehicle types such as commercial/performance EVs, e-buses, e-trucks, heavy machinery, e-boats, and e-aircraft/electric vertical take-off and landing vehicles (eVTOLs). Additionally, the charging modules can be directly connected to DC-micro grids, which can enable increased power efficiency while providing reduction in the number of power conversion stages, station size and installation cost. Furthermore, the direct DC-connection feature can facilitate the use of renewable energy sources to promote sustainable and greener charging.

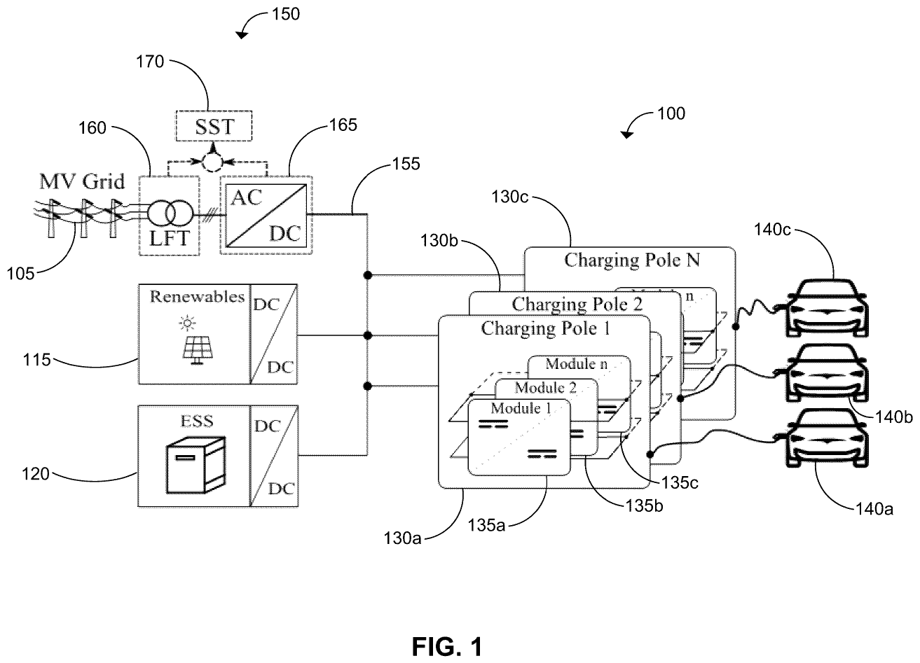

Reference is made to FIG. 1, which illustrates a schematic view of a DC-connected charging station 100 in accordance with an example embodiment. In the illustrated embodiment, charging station 100 includes multiple charging poles 130a-130c. Charging poles 130 deliver/receive regulated power to/from EVs 140a-140c under the control of a supply equipment charging controller.

Charging station 100 is coupled to a DC-micro grid 150 using a shared DC-bus 155. Shared DC-bus 155 can enable bidirectional power transfer between charging station 100 and DC-micro grid 150. DC-micro grid 150 is electrically connected to a medium voltage (MV) grid 105, a renewable power source(s) 115, and an energy storage system (ESS) 120. MV grid 105 is connected to DC-micro grid 150 using a two-stage structure—a low-frequency transformer (LFT) 160 and a central front-end rectifier 165. In some embodiments, MV grid 105 may be connected to DC-micro grid 150 using a smaller, more efficient single-stage solid-state transformer (SST) 170.

Each charging pole 130 includes multiple charging modules 135a-135c stacked together and connected in a parallel input/output configuration. Depending on the charging station power requirements and target vehicle capacity, the number of charging poles 130 (N) and the number of charging modules 135 (n) stack can be determined. Dynamic DC-power sharing between charging poles can be performed in the case of high-power charging scenarios to increase the station's cost effectiveness.

In the various embodiments disclosed herein, each charging module 135 can have a universal output voltage range. For example, in some cases, the universal output voltage range can extend from 200V to 1000V at a power level of 10 KW. In some embodiments, the charging modules 135 of each charging pole 130 can be combined in parallel to increase the charging power to ultra-fast power levels, such as, for example, power levels above 350 kW.

Each charging module 135 has an internal structure including one or more interleaved power conversion sub-modules. The number, topology, and structure of sub-modules included in a module may depend on the application's power and voltage requirements, in addition to cost and performance targets, as such different sub-module topologies may be used based on the requirements of each charging application.

It's important to note that the schematic view shown in FIG. 1 is only an example and not limiting to the use cases of the proposed charger modules. For example, in some cases the module's input can be connected directly to a variable voltage bus coming from photovoltaics (PVs) or ESSs without the use of intermediate DC/DC stages and still performing its role as a charger.

Table 1 shows an example of various vehicle types 140 and corresponding battery voltage needs.

TABLE 1
ELECTRIC VEHICLE BATTERIES

| | | Battery |
|---|---|---|
| Vehicle | | Voltage |
| Type | OEM-Model | [V] |
| Sedan | Nissan-Leaf | *360 |
| | Tesla-Model S | *450 |
| Bus | Volvo-7900 Electric | *690 |
| Supercar | Porsche-Tycan | *723 |
| Hypercar | Rimac-Nevera | **730 |
| Aircraft | Rolls Royce-Spirit of Innovation | *750 |

*Nominal Voltage,
**Max Voltage.

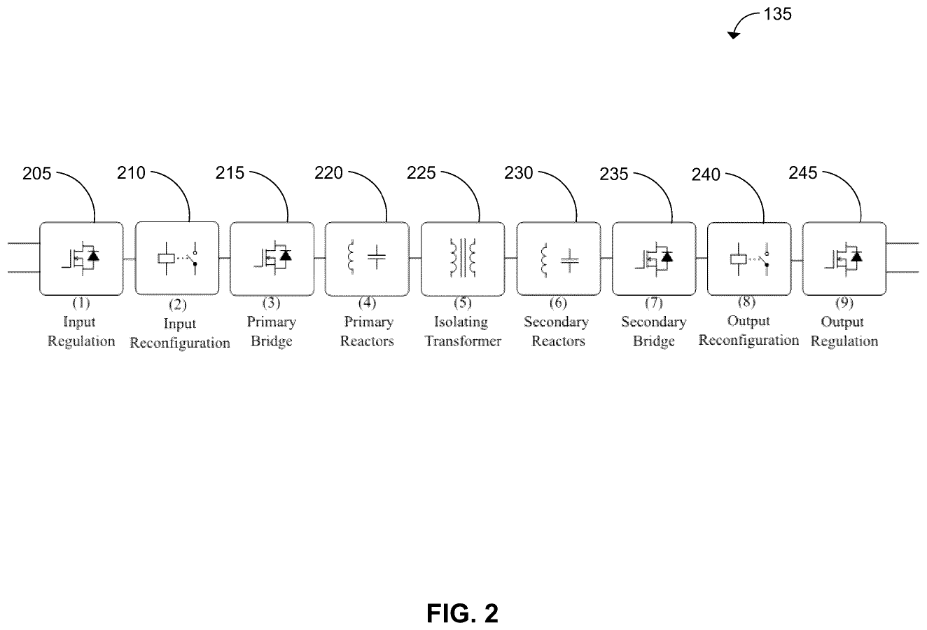

Reference is next made to FIG. 2, which illustrates a generalized structure for a charging module 135. As shown, the building blocks or power conversion stages 205-245 are categorized into nine different units:

(1) Input Regulation 205 includes a non-isolated DC-DC buck/boost converter. The DC-DC buck/boost converter may be unidirectional or bidirectional.

(2) Input Reconfiguration 210 includes a switch matrix that reconfigures the DC input connection of the internal primary bridge units.

(3) Primary Bridge 215 can include a two-level or a multi-level single-phase inverter. In some embodiments, the inverter is a controlled rectifier.

(4) Primary Reactors 220 can include inductive and/or capacitive elements on the primary winding of the isolating transformer to achieve smooth power transfer and/or soft switching.

(5) Isolating Transformer 225 can include a single-phase multi-winding transformer or multiple separate single-phase transformer units.

(6) Secondary Reactors 230 can include inductive and/or capacitive elements on the secondary winding of the isolating transformer to achieve smooth power transfer and/or soft switching.

(7) Secondary Bridge 235 can include a two-level or a multi-level single-phase inverter. In some embodiments, the inverter is a controlled rectifier.

(8) Output Reconfiguration 240 includes a switch matrix that reconfigures the DC output connection of the internal secondary bridge units.

(9) Output Regulation 245 includes a non-isolated buck/boost DC-DC converter. The DC-DC buck/boost converter may be unidirectional or bidirectional.

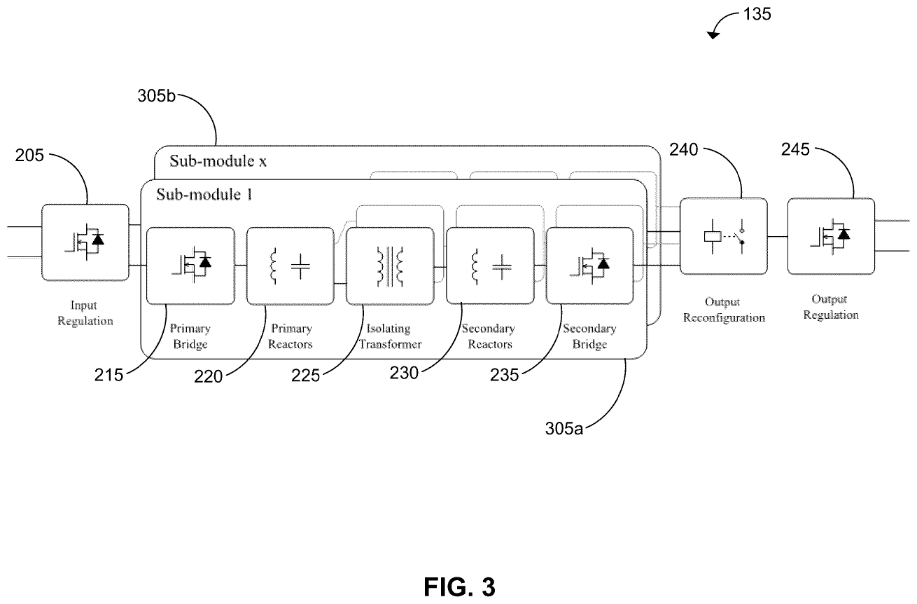

Reference is next made to FIG. 3, which illustrates a generalized sub-module structure for a charging module 135. Charging module 135 may have any suitable number of sub-modules 305 based on the charging power requirements. For example, charging module 135 may have a single sub-module 305 for scaled-down charging power requirements. In other examples, charging module 135 may have a higher number (x) of sub-modules 305 for higher charging power requirements (e.g., sub-modules 305a and 305b shown in FIG. 3). A charging pole may be designed with a higher number (n) of stacked charging modules and/or higher number (x) of sub-modules for high charging power scenarios.

Two examples of DC-DC power converter topologies for charging modules are described and filed under two U.S. patents. The first example is a two-level primary-side and reconfigurable secondary-side DC/DC dual active bridge described under U.S. Patent Application No. 63/435,087 (filed Dec. 23, 2022). The second is a two-level primary-side and reconfigurable secondary-side DC/DC LLC resonant converter which is described in U.S. patent application Ser. No. 18/110,972 (filed Feb. 17, 2023), the entire contents of both of which are hereby incorporated by reference. These topologies extend the converter output charging voltage range without operating far from the unity point which reduces the converter circulating current. Additionally, each rectifier is only subjected to half the output voltage, which reduces the secondary side devices voltage rating. Further, this topology modularity allows full utilization of all the components at the two modes.

Described next are further DC-DC power converter topologies that may be used for implementing charging modules 135 in accordance with various embodiments. The switches used in primary and secondary bridge circuits can be any suitable switching devices. For example, the switches can be active SiC FETs, passive SiC diodes etc.

### Two-Level Primary-Side and Reconfigurable Secondary-Side DC/DC CLLC Resonant Converter

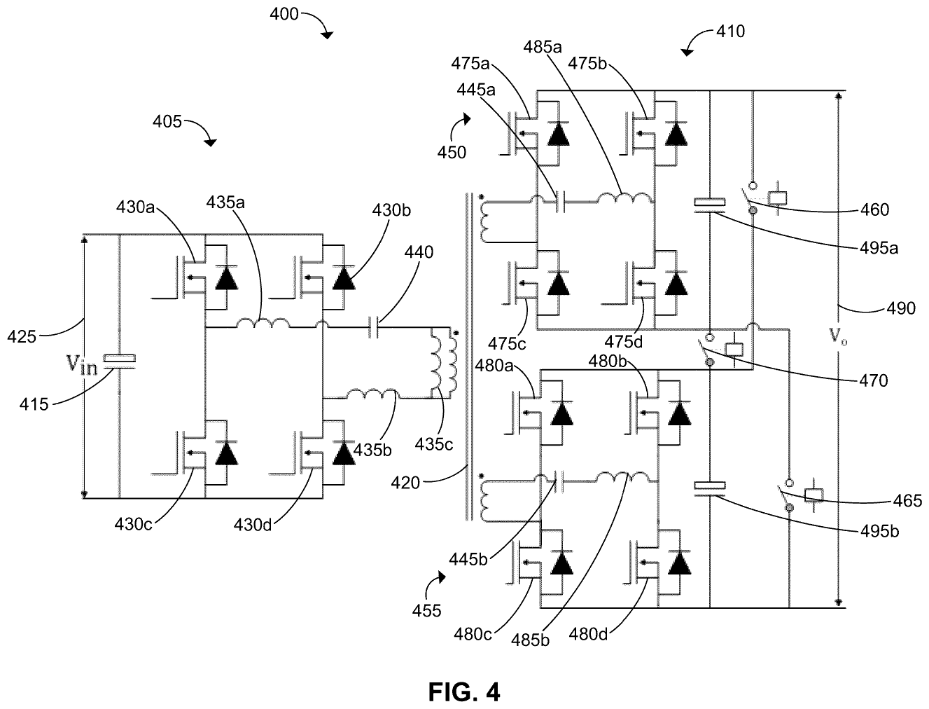

Reference is next made to FIG. 4, which illustrates a schematic view of an example DC-DC power converter topology 400 having a primary sub-circuit 405 and a secondary sub-circuit 410. Primary sub-circuit 405 and secondary sub-circuit 410 are coupled with each other using a gapped transformer Tᵣ (420) to provide isolation between the primary 405 and secondary 410 sub-circuits, and particularly the input and output bridges.

Primary sub-circuit 405 includes an input voltage Vᵢₙ (425), an input capacitor 415, full-bridge switches S₁, S₂, S₃, S₄ (430a-430d), resonant inductor Lᵣ (435a and 435b), and resonant capacitor Cᵣ (440). Transformer 420 has a magnetizing inductance Lₘ (435c) and may be designed to have a low leakage inductance that is neglected during the design process. Topology 400 can achieve operation in zero voltage switching (ZVS) at almost every operating point.

Secondary sub-circuit 410 includes a first secondary sub-circuit 450 and a second secondary sub-circuit 455. In the illustrated example, each of first secondary sub-circuit 450 and second secondary sub-circuit 455 includes a full-bridge switching circuit with high frequency current sensor for synchronous rectification. First secondary sub-circuit 450 includes four switches 475, including a first secondary switch 475a, a second secondary switch 475b, a third secondary switch 475c and a fourth secondary switch 475d. Second secondary sub-circuit 455 includes four switches 480, including a first secondary switch 480a, a second secondary switch 480b, a third secondary switch 480c and a fourth secondary switch 480d. Switches 475 and 480 can be any suitable switching devices. For example, switches 475 and/or 480 can be active SiC FETs, passive SiC diodes etc. First secondary sub-circuit 450 also includes a capacitor 445a, an inductor 485a and an output capacitor 495a. Second secondary sub-circuit 455 also includes a capacitor 445b, an inductor 485b and an output capacitor 495b.

Secondary sub-circuit 410 also includes three transition switches (460, 465, and 470) that connect first secondary sub-circuit 450 and second secondary sub-circuit 455 in parallel or series configurations. In parallel mode (PM), the transition switches Sₚ₁ (460) and Sₚ₂ (465) are closed and Sₛ (470) is open. In series mode (SM) the transition switch Sₛ (470) is closed, while Sₚ₁ (460) and Sₚ₂ (465) are open. Switching between the SM and PM can achieve double the output voltage range compared with a conventional DC-DC converter topology. The converter may operate at PM for low output voltages, and at SM for high output voltages.

Transition switches 460, 465, and 470 are bidirectional switches. In some examples, transition switches 460, 465, and 470 are relays. In other examples, transition switches 460, 465, and 470 are any low frequency, bidirectional switches. In some embodiments, transition switches 460, 465, and 470 are contactors. In addition to facilitating switching of the DC-DC power converter between the two modes of operation, the contactors may also provide the benefit of protecting and isolating the secondary sub-circuits 450, 455 for safe operation.

Output voltage 490 can be controlled by varying the switching frequency of the primary side. Below the resonant frequency, the converter operates in boosting mode. Above the resonant frequency, the converter operates in bucking mode. At the resonant frequency, it has unity gain.

Topology 400 provides an additional unity gain point, allowing the converter to operate in the vicinity of the resonant frequency, limiting the efficiency drop over the wide gain range. Additionally, topology 400 allows bidirectional power flow. Furthermore, topology 400 reflects the same load on the primary-side resonant tank during the two secondary configurations (SM and PM) allowing the converter to operate at the same conditions, such as quality factor (Q_e) and normalized switching frequency (f_n). By reducing the converter gain and load ranges, the resonant tank parameters design can be drastically simplified. Additionally, the circulating current in the primary current is reduced, increasing the efficiency and allowing the usage of lower current ratings primary-side switches, resonant components, and a smaller transformer. Additionally, each rectifier is only subjected to half the output voltage, which reduces the secondary side devices voltage rating. Topology 400 also allows full utilization of all the components at the two modes.

### Three-Level Primary-Side and Reconfigurable Secondary-Side DC/DC Dual-Active Bridge (DAB)

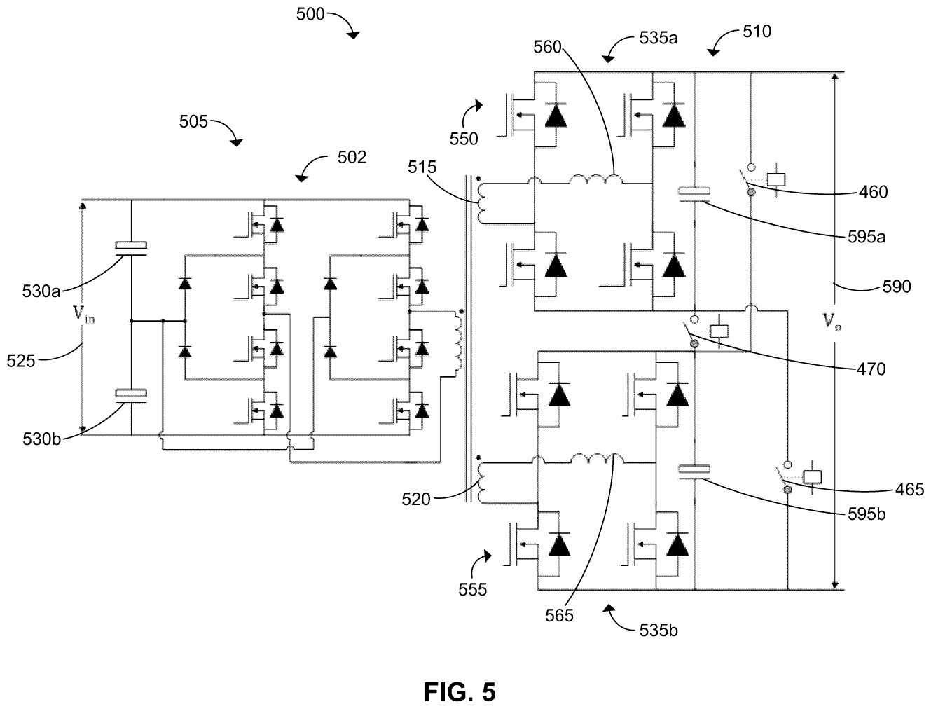

Reference is next made to FIG. 5, which illustrates a schematic view of an example DC-DC power converter topology 500 having a primary sub-circuit 505 and a secondary sub-circuit 510.

Primary sub-circuit 505 includes an input voltage Vᵢₙ (525), a first input capacitor 530a and a second input capacitor 530b and three-level (3L) neutral-point (NP)-clamped (3L NPC) converters 502 allowing application of different voltage levels, which increases the output voltage gain. Two secondary transformers 515 and 520 provide isolation and transfer equal power share to each secondary. The transformer is designed to have a low leakage inductance to be neglected during the design process. The inductor enables the switches of the primary sub-circuit to achieve zero-voltage switching.

Secondary sub-circuit 510 includes a first secondary sub-circuit 550 and a second secondary sub-circuit 555. In the illustrated example, each of first secondary sub-circuit 550 and second secondary sub-circuit 555 includes a full-bridge switching circuit (535a, 535b). Each of first secondary sub-circuit 550 and second secondary sub-circuit 555 includes an inductor (560, 565) that can be integrated into the transformer and/or implemented externally as a shim inductor. Each of first secondary sub-circuit 550 and second secondary sub-circuit 555 also include an output capacitor (595a, 595b).

Secondary sub-circuit 510 also includes three transition switches (460, 465, and 470) that connect first secondary sub-circuit 550 and second secondary sub-circuit 555 in parallel or series configurations. In parallel mode (PM), the transition switches Sₚ₁ (460) and Sₚ₂ (465) are closed and Sₛ (470) is open. In series mode (SM) the transition switch Sₛ (470) is closed, while Sₚ₁ (460) and Sₚ₂ (465) are open. Switching between the SM and PM can achieve double the output voltage range compared with a conventional DC-DC converter topology. The converter may operate at PM for low output voltages, and at SM for high output voltages.

Topology 500 can enable using 5 phase shifts which increases the converter output power and voltage range, without losing ZVS operation or high circulating current that can cause higher conduction losses. Topology 500 provides an additional unity gain point, allowing the converter to operate in the vicinity of the unity gain, limiting the efficiency drop over the wide gain range. Furthermore, topology 500 enables full utilization of all the components at the two modes.

Output voltage 590 can be controlled by varying the phase-shift between primary sub-circuit 505 and secondary sub-circuit 510. Higher powers can be transferred to the load using higher values of the phase-shift.

Three-Level DC-DC DAB Converter with Reconfigurable Dual-Secondary and Flying Capacitors

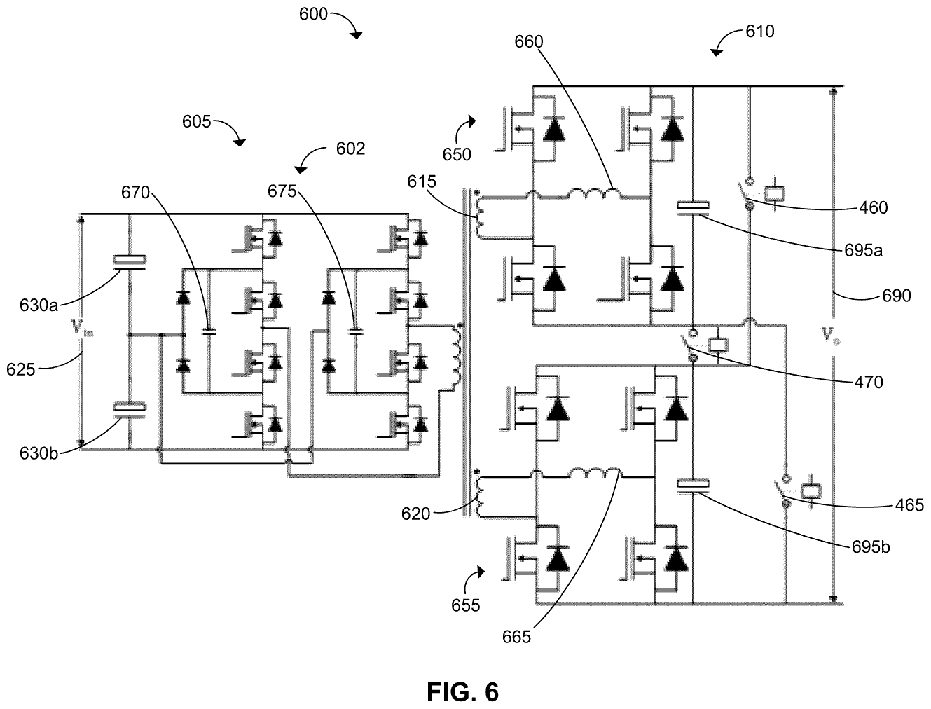

Reference is next made to FIG. 6, which illustrates a schematic view of an example DC-DC power converter topology 600 having a primary sub-circuit 605 and a secondary sub-circuit 610.

Primary sub-circuit 605 includes an input voltage Vᵢₙ (625), input capacitors 630a and 630b, flying capacitors 670, 675, and 3-L neutral point clamped converters 602 allowing application of different voltage levels, which increases the output voltage gain. Two secondary transformers 615 and 620 provide isolation and transfer equal power share to each secondary. The transformer is designed to have a low leakage inductance to be neglected during the design process. The inductor enables the switches of the primary sub-circuit to achieve zero-voltage switching.

Secondary sub-circuit 610 includes a first secondary sub-circuit 650 and a second secondary sub-circuit 655. In the illustrated example, each of first secondary sub-circuit 650 and second secondary sub-circuit 655 includes a full-bridge switching circuit. Each of first secondary sub-circuit 650 and second secondary sub-circuit 655 includes an inductor (660, 665) that can be integrated into the transformer and/or implemented externally as a shim inductor. Each of first secondary sub-circuit 650 and second secondary sub-circuit 655 includes an output capacitor (695a, 695b).

Secondary sub-circuit 610 also includes three transition switches (460, 465, and 470) that connect first secondary sub-circuit 650 and second secondary sub-circuit 655 in parallel or series configurations. In parallel mode (PM), the transition switches Sₚ₁ (460) and Sₚ₂ (465) are closed and Sₛ (470) is open. In series mode (SM) the transition switch Sₛ (470) is closed, while Sₚ₁ (460) and Sₚ₂ (465) are open. Switching between the SM and PM can achieve double the output voltage range compared with a conventional DC-DC converter topology. The converter may operate at PM for low output voltages, and at SM for high output voltages.

Topology 600 can enable using 5 phase shifts which increases the converter output power and voltage range, without losing ZVS operation or high circulating current that can cause higher conduction losses. Topology 500 provides an additional unity gain point, allowing the converter to operate in the vicinity of the unity gain, limiting the efficiency drop over the wide gain range. Furthermore, topology 500 enables full utilization of all the components at the two modes. Additionally, flying capacitors 670 and 675 achieve passive voltage balancing for the capacitors of primary sub-circuit 605.

Output voltage 690 can be controlled by varying the phase-shift between primary sub-circuit 605 and secondary sub-circuit 610. Higher powers can be transferred to the load using higher values of the phase-shift.

Three-Level DC-DC LLC Converter with Reconfigurable Dual-Secondary

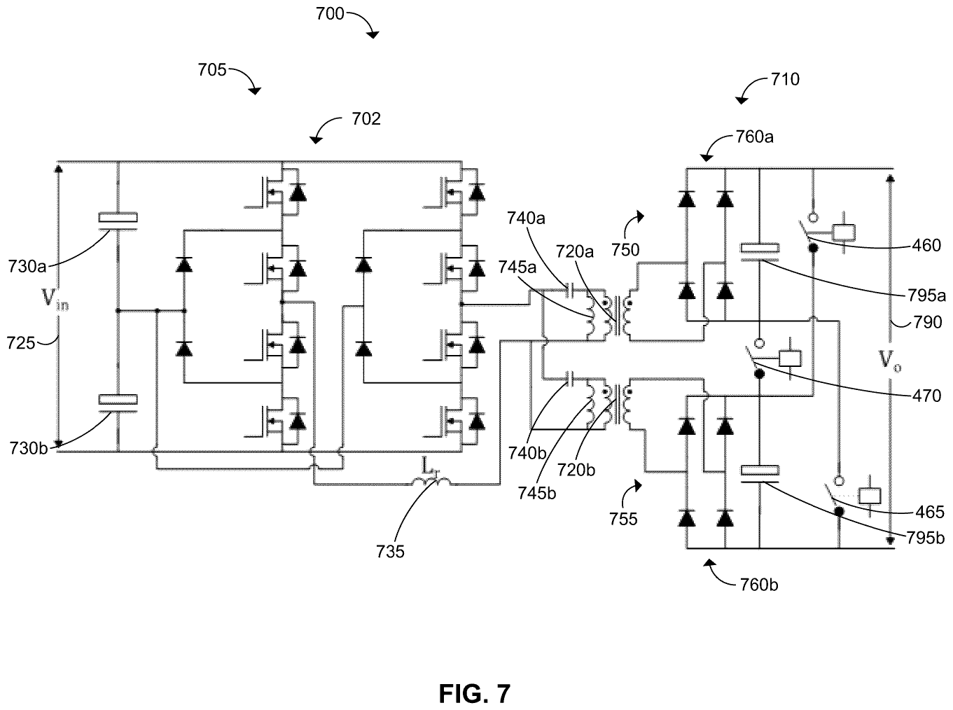

Reference is next made to FIG. 7, which illustrates a schematic view of an example DC-DC power converter topology 700 having a primary sub-circuit 705 and a secondary sub-circuit 710.

Primary sub-circuit 705 includes an input voltage Vᵢₙ (725), input capacitors 730a and 730b, and 3-L neutral point clamped converters 702 allowing application of different voltage levels, which increases the output voltage gain. Primary sub-circuit 705 also includes a resonant inductor Lᵣ (735) and resonant capacitor split into two Cᵣ/2 capacitors (740a and 740b).

Primary sub-circuit 705 and secondary sub-circuit 710 are coupled with each other using two gapped transformers Tr₁ (720a) and Tr₂ (720b) to provide isolation between the input and output bridges. Each gapped transformer 720 has a magnetizing inductance 2Lₘ (745a, 745b), where Lₘ is the required magnetizing inductance. Transformers 720 are designed to have a low leakage inductance to be neglected during the design process. The inductor enables the switches of the primary sub-circuit to achieve zero-voltage switching at all operating points.

Secondary sub-circuit 610 includes a first secondary sub-circuit 750 and a second secondary sub-circuit 755. In the illustrated example, each of first secondary sub-circuit 750 and second secondary sub-circuit 755 includes a full-bridge diode rectifier circuit (760a, 760b) and an output capacitor (795a, 795b).

Secondary sub-circuit 710 also includes three transition switches (460, 465, and 470) that connect first secondary sub-circuit 750 and second secondary sub-circuit 755 in parallel or series configurations. In parallel mode (PM), the transition switches Sₚ₁ (460) and Sₚ₂ (465) are closed and Sₛ (470) is open. In series mode (SM) the transition switch Sₛ (470) is closed, while Sₚ₁ (460) and Sₚ₂ (465) are open. Switching between the SM and PM can achieve double the output voltage range compared with a conventional DC-DC converter topology. The converter may operate at PM for low output voltages, and at SM for high output voltages.

The 3-level primary configuration of topology 700 provides several voltage levels and phase shifts which increases the output voltage gain without operating far from the resonant frequency, increasing the converter efficiency. Topology 700 provides an additional unity gain point, allowing the converter to operate in the vicinity of the unity gain, limiting the efficiency drop over the wide gain range. Furthermore, topology 700 enables full utilization of all the components at the two modes.

Output voltage 790 can be controlled by varying the switching frequency of primary sub-circuit 705. Below the resonant frequency, the converter operates in boosting mode. Above the resonant frequency, the converter operates in bucking mode. At the resonant frequency, the converter has unity gain.

Three-Level DC-DC LLC Converter with Reconfigurable Dual-Secondary and Flying Capacitors

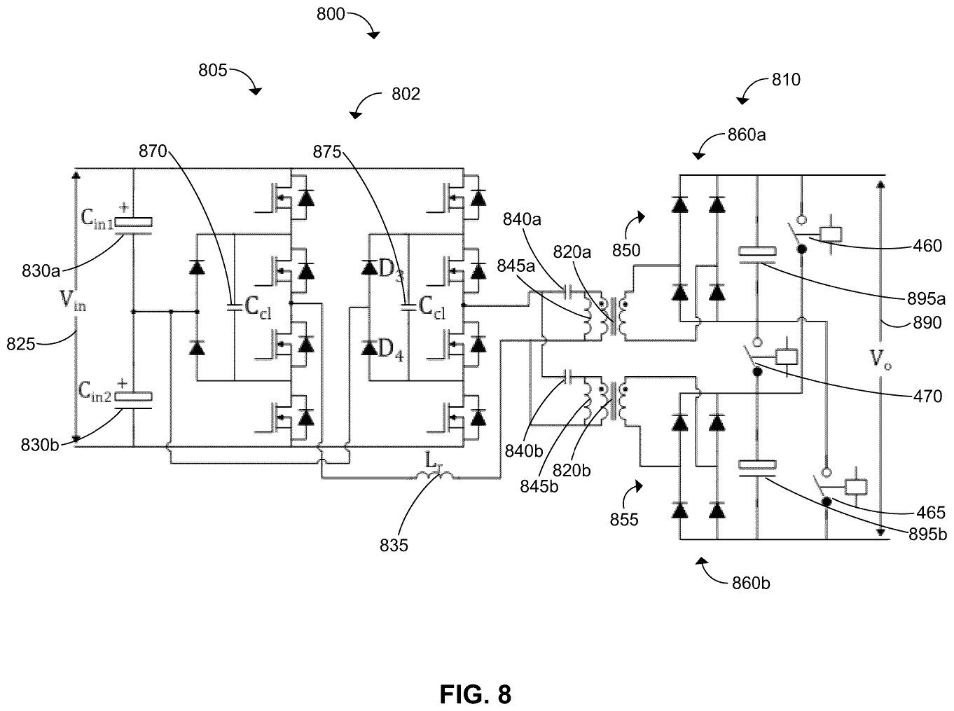

Reference is next made to FIG. 8, which illustrates a schematic view of an example DC-DC power converter topology 800 having a primary sub-circuit 805 and a secondary sub-circuit 810.

Primary sub-circuit 805 includes an input voltage Vᵢₙ (825) (applied at input capacitors 830a and 830b), and 3-L neutral point clamped converters 802 allowing application of different voltage levels, which increases the output voltage gain. Primary sub-circuit 805 also includes a resonant inductor Lᵣ (835), resonant capacitor split into two Cᵣ/2 capacitors (840a and 840b), and flying capacitors 870 and 875.

Primary sub-circuit 805 and secondary sub-circuit 810 are coupled with each other using two gapped transformers Tr₁ (820a) and Tr₂ (820b) to provide isolation between the input and output bridges. Each gapped transformer 820 has a magnetizing inductance 2Lₘ (845a, 845b), where Lₘ is the required magnetizing inductance. Transformers 820 are designed to have a low leakage inductance to be neglected during the design process. The inductor enables the switches of the primary sub-circuit to achieve zero-voltage switching at all operating points.

Secondary sub-circuit 810 includes a first secondary sub-circuit 850 and a second secondary sub-circuit 855. In the illustrated example, each of first secondary sub-circuit 850 and second secondary sub-circuit 855 includes a full-bridge diode rectifier circuit (860a, 860b) and an output capacitor (895a, 895b).

Secondary sub-circuit 810 also includes three transition switches (460, 465, and 470) that connect first secondary sub-circuit 850 and second secondary sub-circuit 855 in parallel or series configurations. In parallel mode (PM), the transition switches Sₚ₁ (460) and Sₚ₂ (465) are closed and Sₛ (470) is open. In series mode (SM) the transition switch Sₛ (470) is closed, while Sₚ₁ (460) and Sₚ₂ (465) are open. Switching between the SM and PM can achieve double the output voltage range compared with a conventional DC-DC converter topology. The converter may operate at PM for low output voltages, and at SM for high output voltages.

The 3-level primary configuration of topology 800 provides several voltage levels and phase shifts which increases the output voltage gain without operating far from the resonant frequency, increasing the converter efficiency. Topology 800 provides an additional unity gain point, allowing the converter to operate in the vicinity of the unity gain, limiting the efficiency drop over the wide gain range. Furthermore, topology 800 enables full utilization of all the components at the two modes. Additionally, flying capacitors 870 and 875 achieve passive voltage balancing for the capacitors of primary sub-circuit 805.

Output voltage 890 can be controlled by varying the switching frequency of primary sub-circuit 805. Below the resonant frequency, the converter operates in boosting mode. Above the resonant frequency, the converter operates in bucking mode. At the resonant frequency, the converter has unity gain.

Three-Level DC-DC CLLC Converter with Reconfigurable Dual-Secondary

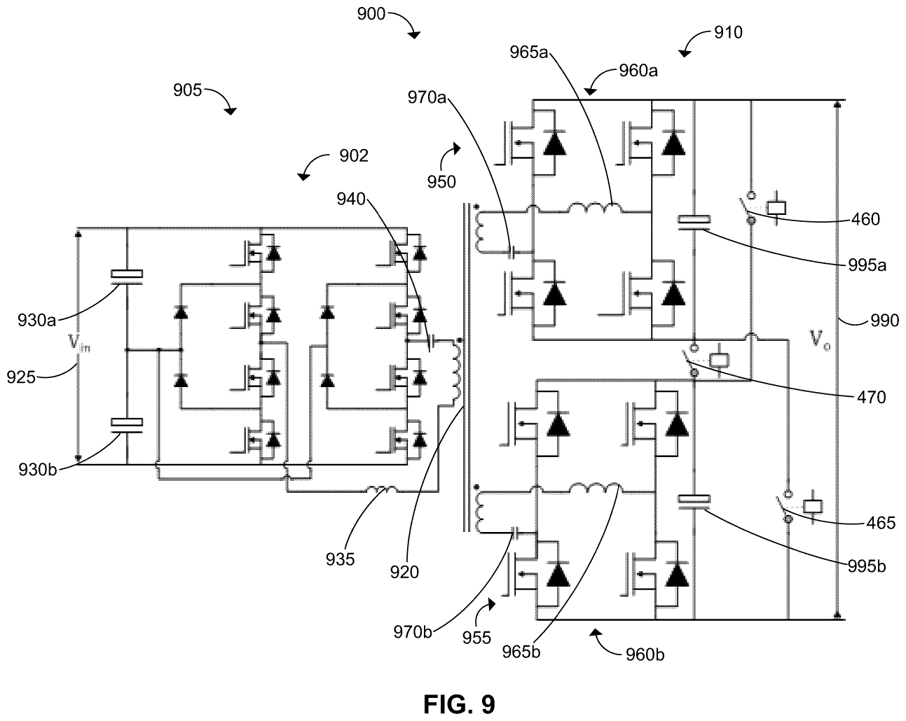

Reference is next made to FIG. 9, which illustrates a schematic view of an example DC-DC power converter topology 900 having a primary sub-circuit 905 and a secondary sub-circuit 910.

Primary sub-circuit 905 includes an input voltage Vᵢₙ (925) (applied at input capacitors 930a and 930b), and 3-L neutral point clamped converters 902 allowing application of different voltage levels, which increases the output voltage gain. Primary sub-circuit 905 also includes a resonant inductor Lᵣ (935), and resonant capacitor Cᵣ (940).

Primary sub-circuit 905 and secondary sub-circuit 910 are coupled with each other using gapped transformer Tr (920) to provide isolation between the input and output bridges. Transformer 920 has a magnetizing inductance Lₘ and is designed to have a low leakage inductance that can be neglected during the design process. The inductor can enable the switches of the primary sub-circuit to achieve zero-voltage switching at most operating points.

Secondary sub-circuit 910 includes a first secondary sub-circuit 950 and a second secondary sub-circuit 955. In the illustrated example, each of first secondary sub-circuit 950 and second secondary sub-circuit 955 includes a full-bridge switching circuit (960a, 960b) with high frequency current sensor for synchronous rectification. Each of first secondary sub-circuit 950 and second secondary sub-circuit 955 also includes a capacitor (970a, 970b), an inductor (965a, 965b), and an output capacitor (995a, 995b).

Secondary sub-circuit 910 also includes three transition switches (460, 465, and 470) that connect first secondary sub-circuit 950 and second secondary sub-circuit 955 in parallel or series configurations. In parallel mode (PM), the transition switches Sₚ₁ (460) and Sₚ₂ (465) are closed and Sₛ (470) is open. In series mode (SM) the transition switch Sₛ (470) is closed, while Sₚ₁ (460) and Sₚ₂ (465) are open. Switching between the SM and PM can achieve double the output voltage range compared with a conventional DC-DC converter topology. The converter may operate at PM for low output voltages, and at SM for high output voltages.

The 3-level primary configuration of topology 900 provides several voltage levels and phase shifts which increases the output voltage gain without operating far from the resonant frequency, increasing the converter efficiency. Topology 900 provides an additional unity gain point, allowing the converter to operate in the vicinity of the unity gain, limiting the efficiency drop over the wide gain range. Furthermore, topology 900 enables full utilization of all the components at the two modes.

Output voltage 990 can be controlled by varying the switching frequency of primary sub-circuit 905. Below the resonant frequency, the converter operates in boosting mode. Above the resonant frequency, the converter operates in bucking mode. At the resonant frequency, the converter has unity gain.

Three-Level DC-DC CLLC Converter with Reconfigurable Dual-Secondary and Flying Capacitors

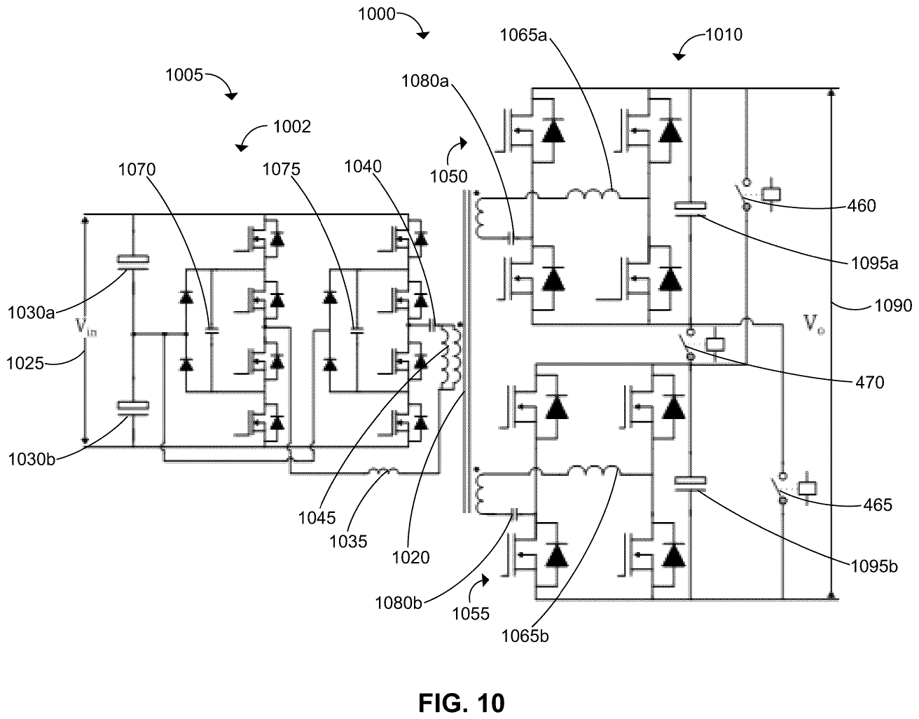

Reference is next made to FIG. 10, which illustrates a schematic view of an example DC-DC power converter topology 1000 having a primary sub-circuit 1005 and a secondary sub-circuit 1010.

Primary sub-circuit 1005 includes an input voltage Vᵢₙ (1025) at input capacitors 1030, and 3-L neutral point clamped converters 1002 allowing application of different voltage levels, which increases the output voltage gain. Primary sub-circuit 1005 also includes a resonant inductor Lᵣ (1035), resonant capacitor Cᵣ (1040), and flying capacitors 1070 and 1075.

Primary sub-circuit 1005 and secondary sub-circuit 1010 are coupled with each other using gapped transformer Tr (1020) to provide isolation between the input and output bridges. Transformer 1020 has a magnetizing inductance Lₘ (1045) and is designed to have a low leakage inductance that can be neglected during the design process. The inductor can enable the switches of the primary sub-circuit to achieve zero-voltage switching at most operating points.

Secondary sub-circuit 1010 includes a first secondary sub-circuit 1050 and a second secondary sub-circuit 1055. In the illustrated example, each of first secondary sub-circuit 1050 and second secondary sub-circuit 1055 includes a full-bridge switching circuit with high frequency current sensor for synchronous rectification. Each of first secondary sub-circuit 1050 and second secondary sub-circuit 1055 also includes a capacitor (1080a, 1080b), an inductor (1065a, 1065b), and an output capacitor (1095a, 1095b).

Secondary sub-circuit 1010 also includes three transition switches (460, 465, and 470) that connect first secondary sub-circuit 1050 and second secondary sub-circuit 1055 in parallel or series configurations. In parallel mode (PM), the transition switches Sₚ₁ (460) and Sₚ₂ (465) are closed and Sₛ (470) is open. In series mode (SM) the transition switch Sₛ (470) is closed, while Sₚ₁ (460) and Sₚ₂ (465) are open. Switching between the SM and PM can achieve double the output voltage range compared with a conventional DC-DC converter topology. The converter may operate at PM for low output voltages, and at SM for high output voltages.

The 3-level primary configuration of topology 1000 provides several voltage levels and phase shifts which increases the output voltage gain without operating far from the resonant frequency, increasing the converter efficiency. Topology 1000 provides an additional unity gain point, allowing the converter to operate in the vicinity of the unity gain, limiting the efficiency drop over the wide gain range. Furthermore, topology 1000 enables full utilization of all the components at the two modes. Additionally, flying capacitors 1070 and 1075 achieve passive voltage balancing for the capacitors of primary sub-circuit 1005.

Output voltage 1090 can be controlled by varying the switching frequency of primary sub-circuit 1005. Below the resonant frequency, the converter operates in boosting mode. Above the resonant frequency, the converter operates in bucking mode. At the resonant frequency, the converter has unity gain.

Two-Level to Three-Level DC-DC DAB Converter with Flying Capacitors

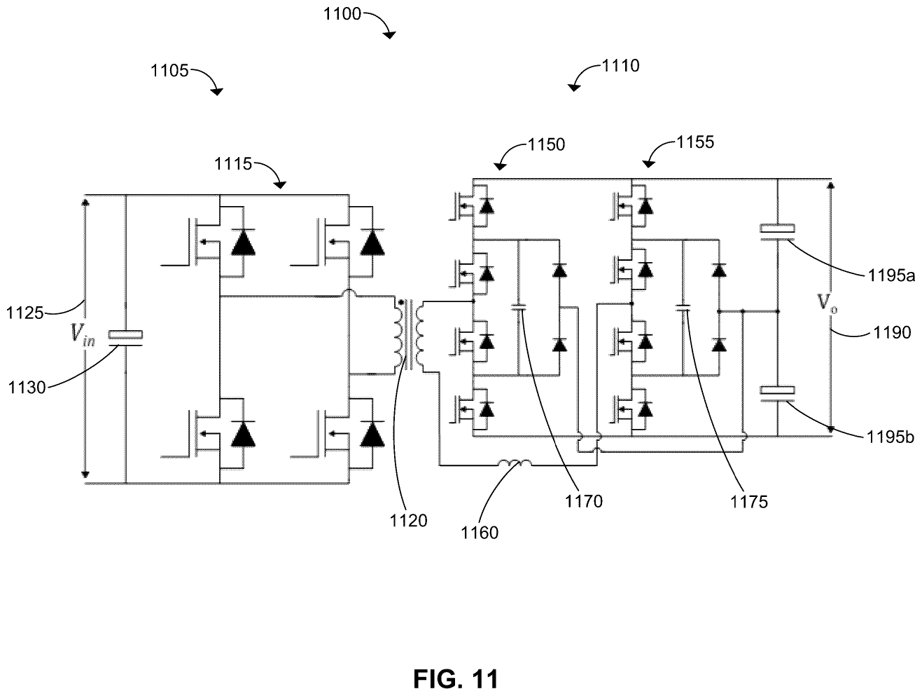

Reference is next made to FIG. 11, which illustrates a schematic view of an example DC-DC power converter topology 1100 having a primary sub-circuit 1105 and a secondary sub-circuit 1110.

Primary sub-circuit 1105 includes an input voltage Vᵢₙ (1125) (applied at input capacitor 1130) and a full-bridge inverter circuit 1115.

Primary sub-circuit 1105 and secondary sub-circuit 1110 are coupled with each other using transformer 1120 to provide isolation between the input and output bridges. Transformer 1120 is designed to have a low leakage inductance that can be neglected during the design process. The inductor can enable the switches of the primary sub-circuit to achieve zero-voltage switching.

Secondary sub-circuit 1110 includes two 3-L inverter circuits (1150 and 1155) with active switches acting as another AC source that can apply different voltage levels and apply additional phase-shift levels, which increase the output voltage gain without operating far from the resonant frequency, increasing the converter efficiency.

Secondary sub-circuit 1110 also includes an inductor 1160 that can be integrated into the transformer and/or implemented externally as a shim inductor. The inductor enables the switches of the inverter circuits to achieve zero-voltage switching. Secondary sub-circuit 1110 also includes output capacitors (1195a, 1195b).

Secondary sub-circuit 1110 further includes flying capacitors 1170 and 1175. Flying capacitors 1170 and 1175 can achieve passive voltage balancing for the capacitors of secondary sub-circuit 1110.

Output voltage 1190 can be controlled by applying phase-shift between primary sub-circuit 1105 and secondary sub-circuit 1110. The 3-level secondary configuration of topology 1100 can enable application of triple phase shift, which increases the controllability of the output voltage and power without adding unnecessary circulating current that can reduce the converter efficiency. Additionally, the configuration of secondary sub-circuit 1110 enables usage of switching devices with lower voltage rating that can provide higher performance and lower cost.

### Two-Level to Three-Level DC-DC DAB Converter

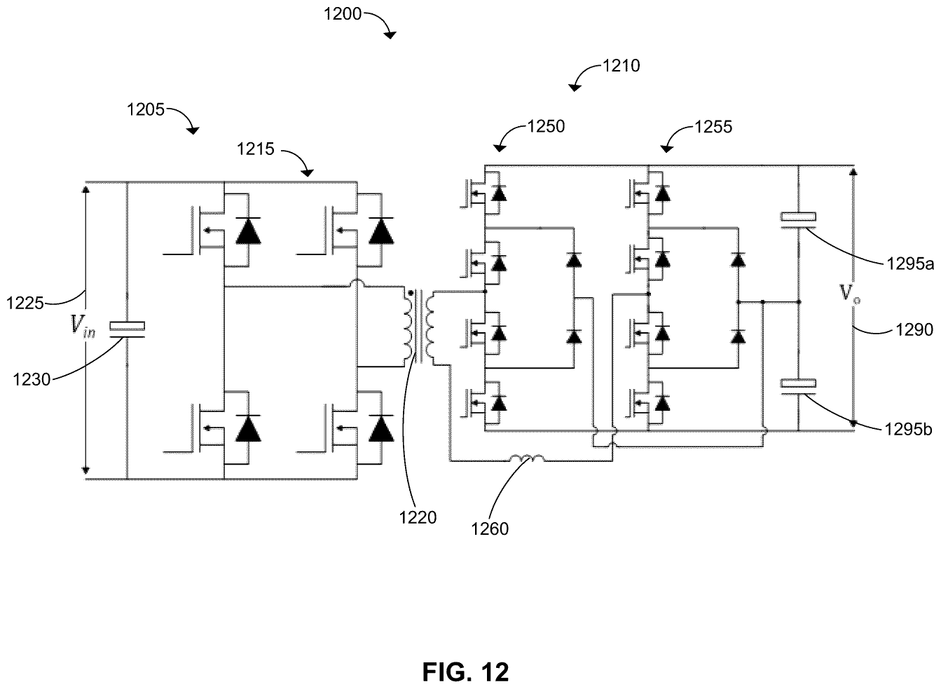

Reference is next made to FIG. 12, which illustrates a schematic view of an example DC-DC power converter topology 1200 having a primary sub-circuit 1205 and a secondary sub-circuit 1210.

Primary sub-circuit 1205 includes an input voltage Vᵢₙ (1225) (applied at input capacitor 1230) and a full-bridge inverter circuit 1215.

Primary sub-circuit 1205 and secondary sub-circuit 1210 are coupled with each other using transformer 1220 to provide isolation between the input and output bridges. Transformer 1220 is designed to have a low leakage inductance that can be neglected during the design process. The inductor can enable the switches of the primary sub-circuit to achieve zero-voltage switching.

Secondary sub-circuit 1210 includes two 3-L inverter circuits (1250 and 1255) with active switches acting as another AC source that can apply different voltage levels and apply additional phase-shift levels, which increase the output voltage gain without operating far from the resonant frequency, increasing the converter efficiency.

Secondary sub-circuit 1210 also includes an inductor 1260 that can be integrated into the transformer and/or implemented externally as a shim inductor. The inductor enables the switches of the inverter circuits to achieve zero-voltage switching. Secondary sub-circuit 1210 also includes output capacitors (1295a, 1295b).

Output voltage 1290 can be controlled by applying phase-shift between primary sub-circuit 1205 and secondary sub-circuit 1210. The 3-level secondary configuration of topology 1200 can enable application of triple phase shift, which increases the controllability of the output voltage and power without adding unnecessary circulating current that can reduce the converter efficiency. Additionally, the configuration of secondary sub-circuit 1210 enables usage of switching devices with lower voltage rating that can provide higher performance and lower cost.

Three-Level DC-DC DAB Converter with Flying Capacitors

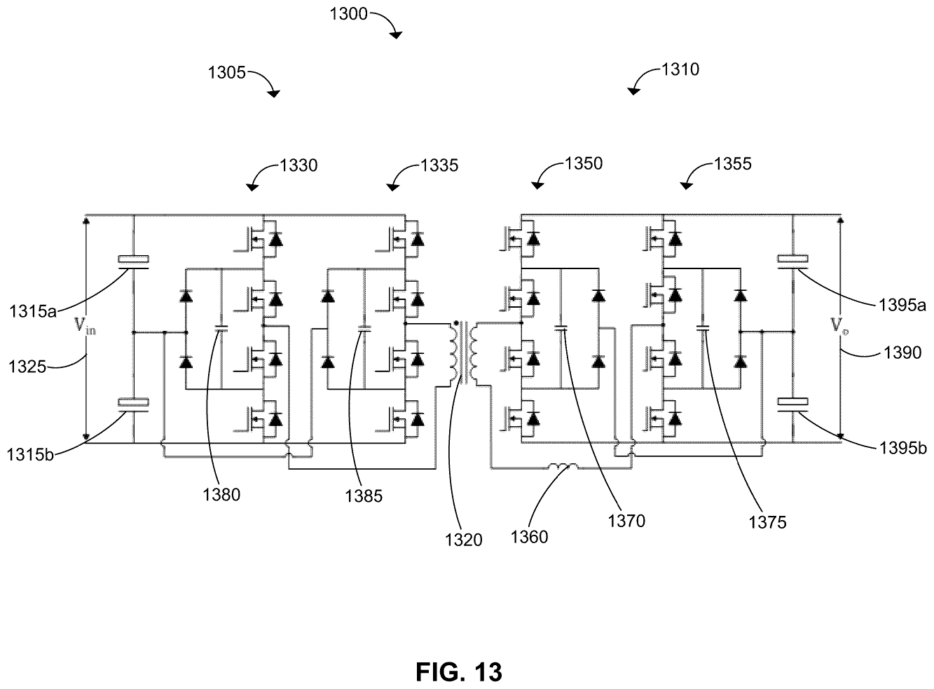

Reference is next made to FIG. 13, which illustrates a schematic view of an example DC-DC power converter topology 1300 having a primary sub-circuit 1305 and a secondary sub-circuit 1310.

Primary sub-circuit 1305 includes an input voltage Vᵢₙ (1325) (applied at input capacitors 1315a, 1315b), two 3-L inverter circuits (1330 and 1335), and flying capacitors 1380 and 1385. This topology allows application of different voltage levels. The 3-level inverter circuits 1330 and 1335 can apply different voltage levels and additional phase-shift levels, which increase the output voltage gain without operating far from the resonant frequency, increasing the converter efficiency. Flying capacitors 1380 and 1385 can achieve passive voltage balancing for the capacitors of primary sub-circuit 1305.

Primary sub-circuit 1305 and secondary sub-circuit 1310 are coupled with each other using transformer 1320 to provide isolation between the input and output bridges.

Secondary sub-circuit 1310 includes two 3-L inverter circuits (1350 and 1355) with active switches acting as another AC source. The 3-level inverter circuits 1350 and 1355 can apply different voltage levels and additional phase-shift levels, which increase the output voltage gain without operating far from the resonant frequency, increasing the converter efficiency. Flying capacitors 1370 and 1375 can achieve passive voltage balancing for the capacitors of secondary sub-circuit 1310.

Secondary sub-circuit 1310 also includes an inductor 1360 that can be integrated into the transformer and/or implemented externally as a shim inductor. The inductor enables the switches of the inverter circuits to achieve zero-voltage switching. Secondary sub-circuit 1310 also includes output capacitors (1395a, 1395b).

Output voltage 1390 can be controlled by applying phase-shift between primary sub-circuit 1305 and secondary sub-circuit 1310. The 3-level configuration of primary sub-circuit 1305 and secondary sub-circuit 1310 can enable application of five levels of phase shift, which increases the controllability of the output voltage and power without adding unnecessary circulating current that can reduce the converter efficiency. Additionally, topology 1300 enables usage of switching devices with lower voltage rating that can provide higher performance and lower cost.

### Three-Level DC-DC DAB Converter

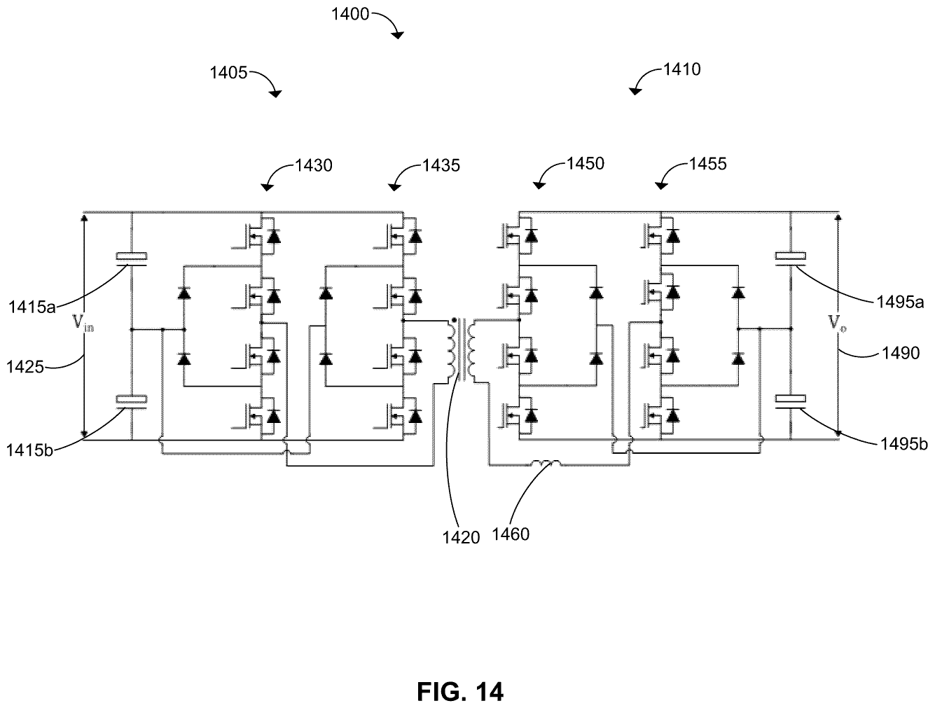

Reference is next made to FIG. 14, which illustrates a schematic view of an example DC-DC power converter topology 1400 having a primary sub-circuit 1405 and a secondary sub-circuit 1410.

Primary sub-circuit 1405 includes an input voltage Vᵢₙ (1425) (applied at input capacitors 1415a, 1415b) and two 3-L inverter circuits (1430 and 1435). Input voltage 1425 is 3-L Neutral Point Clamped allowing application of different voltage levels. The 3-level inverter circuits 1430 and 1435 can apply different voltage levels and additional phase-shift levels, which increase the output voltage gain without operating far from the resonant frequency, increasing the converter efficiency.

Primary sub-circuit 1405 and secondary sub-circuit 1410 are coupled with each other using transformer 1420 to provide isolation between the input and output bridges.

Secondary sub-circuit 1410 includes two 3-L inverter circuits (1450 and 1455) with active switches acting as another AC source. The 3-level inverter circuits 1450 and 1455 can apply different voltage levels and additional phase-shift levels, which increase the output voltage gain without operating far from the resonant frequency, increasing the converter efficiency.

Secondary sub-circuit 1410 also includes an inductor 1460 that can be integrated into the transformer and/or implemented externally as a shim inductor. The inductor enables the switches of the inverter circuits to achieve zero-voltage switching. Secondary sub-circuit 1410 also includes output capacitors (1495a, 1495b)

Output voltage 1490 can be controlled by applying phase-shift between primary sub-circuit 1405 and secondary sub-circuit 1410. The 3-level configuration of primary sub-circuit 1405 and secondary sub-circuit 1410 can enable application of five levels of phase shift, which increases the controllability of the output voltage and power without adding unnecessary circulating current that can reduce the converter efficiency. Additionally, topology 1400 enables usage of switching devices with lower voltage rating that can provide higher performance and lower cost.

Three-Level DC-DC CLLC Converter with Flying Capacitors

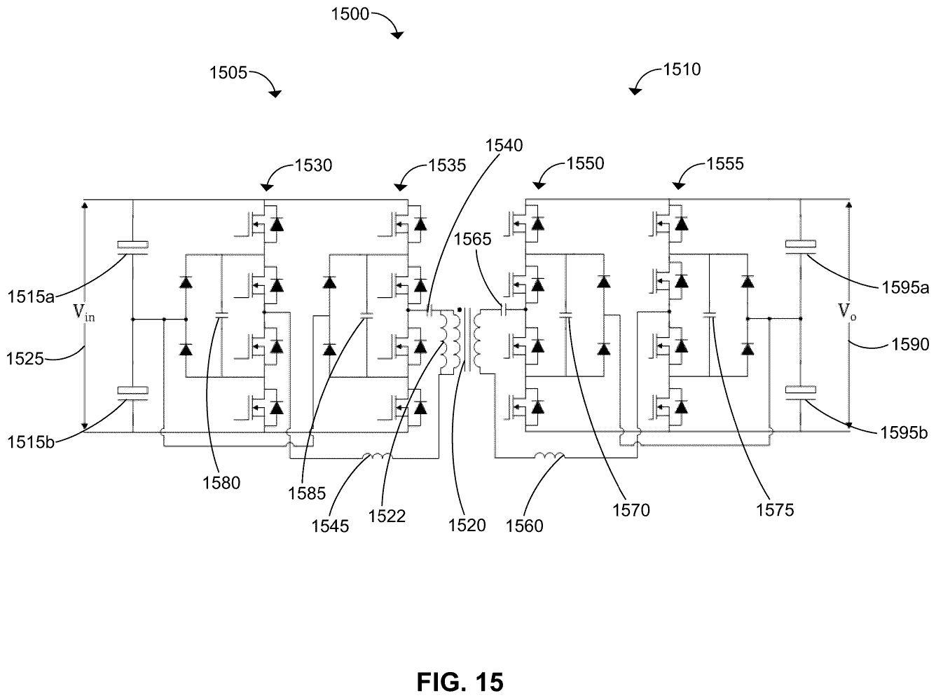

Reference is next made to FIG. 15, which illustrates a schematic view of an example DC-DC power converter topology 1500 having a primary sub-circuit 1505 and a secondary sub-circuit 1510.

Primary sub-circuit 1505 includes an input voltage Vᵢₙ (1525) (applied at input capacitors 1515a, 1515b), two 3-L inverter circuits (1530 and 1535), resonant capacitor Cᵣ (1540), resonant inductor Lᵣ (1545), and flying capacitors 1580 and 1585. The topology allows application of different voltage levels. The 3-level inverter circuits 1530 and 1535 can apply different voltage levels and additional phase-shift levels, which increase the output voltage gain without operating far from the unity gain and resonant frequency, increasing the converter efficiency. Flying capacitors 1580 and 1585 can achieve passive voltage balancing for the capacitors of primary sub-circuit 1505.

Primary sub-circuit 1505 and secondary sub-circuit 1510 are coupled with each other using gapped transformer Tᵣ (1520) to provide isolation between the input and output bridges. Transformer 1520 has magnetizing inductance Lₘ (1522). Transformer 1520 is designed to have a low leakage inductance that can be neglected during the design process.

Secondary sub-circuit 1510 includes two 3-L inverter circuits (1550 and 1555) with active switches acting as another AC source. The 3-level inverter circuits 1550 and 1555 can apply different voltage levels and additional phase-shift levels, which increase the output voltage gain without operating far from the unity gain and resonant frequency, increasing the converter efficiency.

Secondary sub-circuit 1510 also includes resonant inductor Lᵣ (1560), resonant capacitor Cᵣ (1565), and flying capacitors 1570 and 1575. Flying capacitors 1570 and 1575 can achieve passive voltage balancing for the capacitors of secondary sub-circuit 1310. Topology 1500 can enable operation in ZVS at most operating points. Secondary sub-circuit 1510 also includes output capacitors (1595a, 1595b).

Output voltage 1590 can be controlled by changing the switching frequency of primary sub-circuit 1505. The 3-level configuration of primary sub-circuit 1505 and secondary sub-circuit 1510 can enable application of different voltage levels, which increases the controllability of the output voltage and power without adding unnecessary circulating current that can reduce the converter efficiency. Additionally, topology 1500 enables usage of switching devices with lower voltage rating that can provide higher performance and lower cost.

### Three-Level DC-DC CLLC Converter

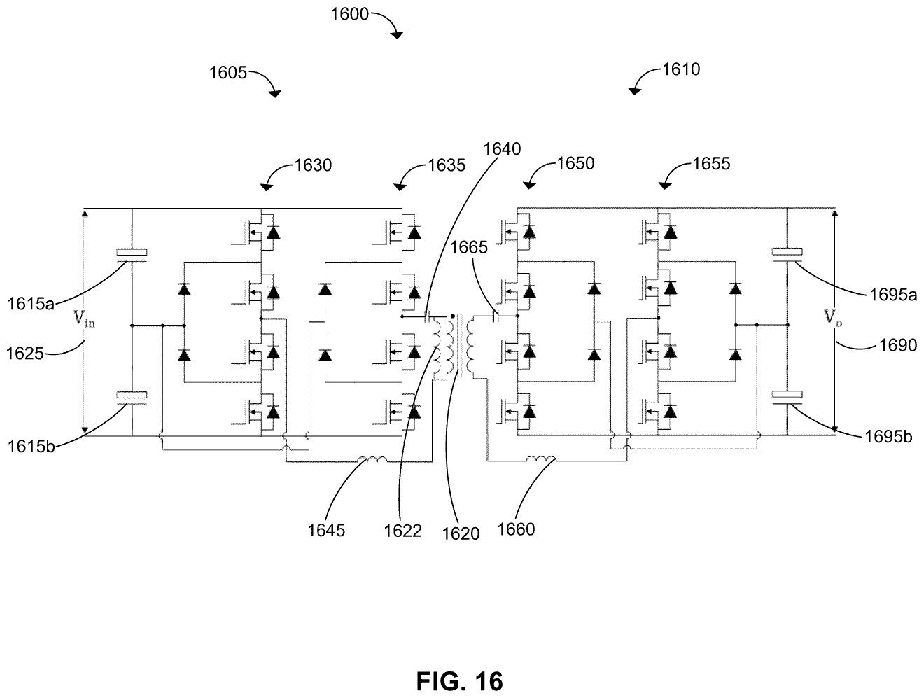

Reference is next made to FIG. 16, which illustrates a schematic view of an example DC-DC power converter topology 1600 having a primary sub-circuit 1605 and a secondary sub-circuit 1610.

Primary sub-circuit 1605 includes an input voltage Vᵢₙ (1625) (applied at input capacitors 1615a, 1615b), two 3-L inverter circuits (1630 and 1635), resonant capacitor Cᵣ (1640), and resonant inductor Lᵣ (1645). The topology allows application of different voltage levels. The 3-level inverter circuits 1630 and 1635 can apply different voltage levels and additional phase-shift levels, which increase the output voltage gain without operating far from the unity gain and resonant frequency, increasing the converter efficiency.

Primary sub-circuit 1605 and secondary sub-circuit 1610 are coupled with each other using gapped transformer Tᵣ (1620) to provide isolation between the input and output bridges. Transformer 1620 has magnetizing inductance Lₘ (1622). Transformer 1620 is designed to have a low leakage inductance that can be neglected during the design process.

Secondary sub-circuit 1610 includes two 3-L inverter circuits (1650 and 1655) with active switches acting as another AC source. The 3-level inverter circuits 1650 and 1655 can apply different voltage levels and additional phase-shift levels, which increase the output voltage gain without operating far from the unity gain and resonant frequency, increasing the converter efficiency. Secondary sub-circuit 1610 also includes resonant inductor Lᵣ (1660), resonant capacitor Cᵣ (1665), and output capacitors (1695a, 1695b). Topology 1600 can enable operation in ZVS at most operating points.

Output voltage 1690 can be controlled by changing the switching frequency of primary sub-circuit 1605. The 3-level configuration of primary sub-circuit 1605 and secondary sub-circuit 1610 can enable application of different voltage levels, which increases the controllability of the output voltage and power without adding unnecessary circulating current that can reduce the converter efficiency. Additionally, topology 1600 enables usage of switching devices with lower voltage rating that can provide higher performance and lower cost.

### Interleaved Three-Level DC-DC for High Power Applications

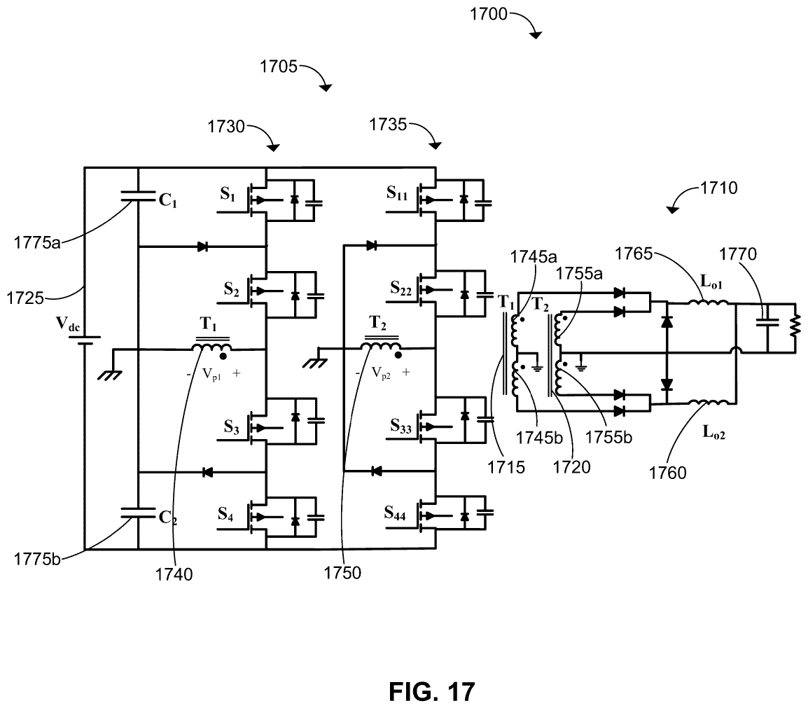

Reference is next made to FIG. 17, which illustrates a schematic view of an example DC-DC power converter topology 1700 having a primary sub-circuit 1705 and a secondary sub-circuit 1710.

Primary sub-circuit 1705 includes an input voltage V_{dc} (1725) (applied at input capacitors 1775a, 1775b) connected to two 3-L half-bridge circuits (1730 and 1735). Each half-bridge circuit 1730 and 1735 can function at full duty cycle, thereby reducing circulating current and conduction losses. This approach can enable topology 1700 to provide high efficiency during operation.

Topology 1700 includes two transformers 1715 and 1720. The primary windings 1740 and 1750 (of transformers 1715 and 1720 respectively) are linked between the AC point of the corresponding half-bridge and the midpoint of the capacitors. Each transformer includes two secondary windings-transformer 1715 includes secondary windings 1745a and 1745b, and transformer 1720 includes secondary windings 1755a and 1755b. Transformers 1715 and 1720 are designed to have a low leakage inductance that can be neglected during the design process.

Secondary sub-circuit 1710 includes two full-wave rectifiers, output inductors 1760 and 1765, and capacitor 1770. Output inductors 1760 and 1765 can enable achievement of ZVS for switches of secondary sub-circuit 1710.

A phase shift can be introduced between the bridge circuits to regulate the output voltage. For topology 1700, power is transferred from primary sub-circuit 1705 to secondary sub-circuit 1710 during both the D and 1-D periods (where D is the duty cycle). This power transfer characteristic can be attributed to the presence of two half bridge circuits within topology 1700, which facilitate energy transfer from the input to the output and the voltage stress across the switches of the bridge circuits is reduced to half the input voltage. Accordingly, topology 1700 can enable utilization of lower voltage rated switching devices, which offer enhanced performance and cost-effectiveness, making topology 1700 particularly suitable for high input voltage applications.

Dual Three-Level DC-DC with Wide ZVS Range

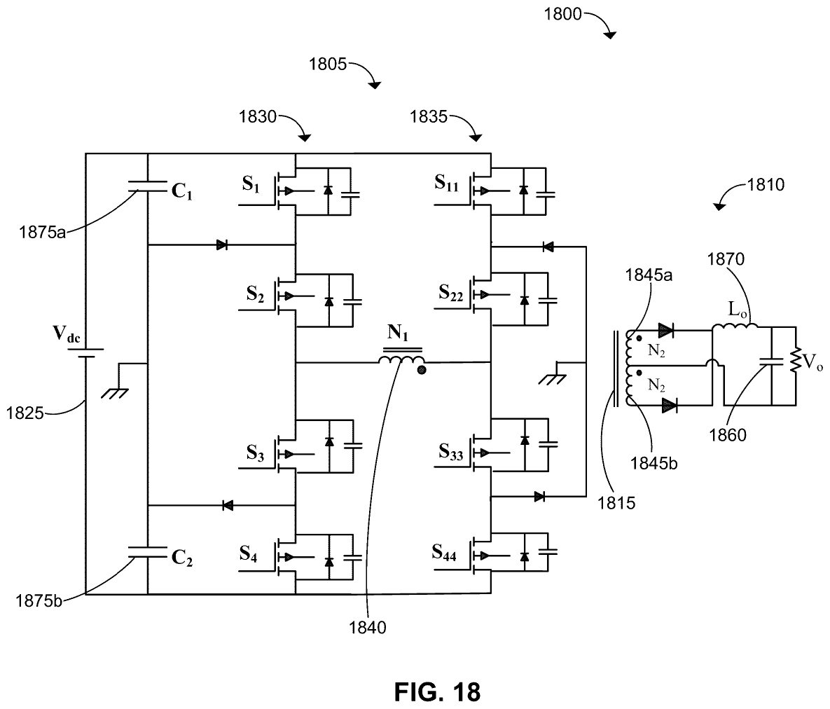

Reference is next made to FIG. 18, which illustrates a schematic view of an example DC-DC power converter topology 1800 having a primary sub-circuit 1805 and a secondary sub-circuit 1810.

Primary sub-circuit 1805 includes an input voltage V_{dc} (1825) (applied at input capacitors 1875a, 1875b) connected to two 3-L half-bridge circuits (1830 and 1835). Each half-bridge circuit 1830 and 1835 can function at full duty cycle, thereby reducing circulating current and conduction losses. This approach can enable topology 1800 to provide high efficiency during operation.

Topology 1800 includes transformer 1815 to provide isolation between the input and the output bridges. The primary winding 1840 of transformer 1815 is linked between the AC points of the two half-bridge circuits 1830 and 1835. Transformer 1815 includes two secondary windings 1845a and 1845b. Transformer 1815 is designed to have a low leakage inductance that can be neglected during the design process.

Secondary sub-circuit 1810 includes two full-wave rectifiers, output inductor 1870, and capacitor 1860. Output inductor 1870 can enable achievement of ZVS for switches of secondary sub-circuit 1810.

A phase shift can be introduced between the bridge circuits to regulate the output voltage. For topology 1800, power is transferred from primary sub-circuit 1805 to secondary sub-circuit 1810 during both the D and 1-D periods (where D is the duty cycle). This power transfer characteristic can be attributed to the presence of two half bridge circuits within topology 1800, which facilitate energy transfer from the input to the output. The voltage stress across the switches of the bridge circuits is thereby reduced to half the input voltage. Accordingly, topology 1800 can enable utilization of lower voltage rated switching devices, which offer enhanced performance and cost-effectiveness, making topology 1800 particularly suitable for high input voltage applications.

### Bidirectional Dual Active Three-Level Two-Level DC-DC Converter

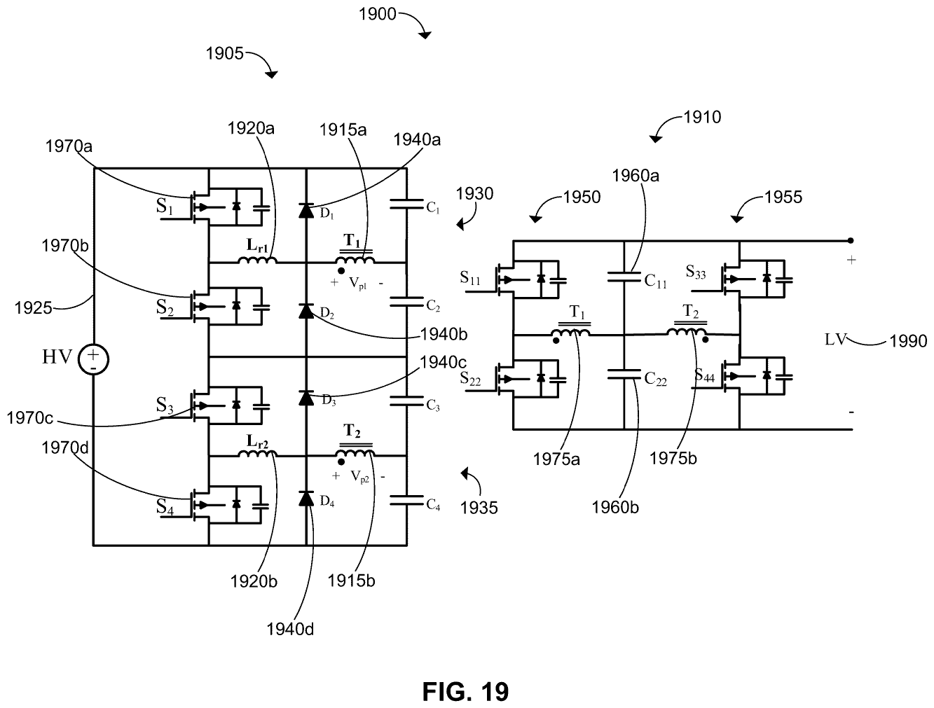

Reference is next made to FIG. 19, which illustrates a schematic view of an example DC-DC power converter topology 1900 having a primary sub-circuit 1905 and a secondary sub-circuit 1910.

Primary sub-circuit 1905 includes an input voltage HV (1925) connected to two half bridges 1930 and 1935 stacked on top of each other. Each half bridge includes an inductor (1920a, 1920b), two clamping diodes (1940a-1940d) and transformer primary winding (1915a, 1915b) in addition to the bridge switches (1970a-1970d). The inductors enable achievement of ZVS for the switches. The clamping diodes minimize any voltage ringing on the transformer primary and secondary sides.

Each half-bridge circuit 1930 and 1935 can function at full duty cycle, thereby reducing circulating current and conduction losses. This approach can enable topology 1900 to provide high efficiency during operation.

The 3L-configuration of primary sub-circuit 1905 can reduce the voltage stress across the switches of the bridge circuits to half the input voltage. Accordingly, topology 1900 can enable utilization of lower voltage rated switching devices, which offer enhanced performance and cost-effectiveness, making topology 1900 particularly suitable for high input voltage applications.

Secondary sub-circuit 1910 includes two half-bridge rectifiers 1950 and 1955 with active switches, each connected to the secondary side of the transformers. Secondary sub-circuit 1910 enables bi-directional power flow between the primary and secondary sub-circuits. Secondary sub-circuit 1910 also includes capacitors (1960a, 1960b) and transformer secondary windings (1975a, 1975b).

A phase shift can be introduced between the bridge circuits to regulate the output voltage 1990. For topology 1900, power is transferred from primary sub-circuit 1905 to secondary sub-circuit 1910 during both the D and 1-D periods (where D is the duty cycle). This power transfer characteristic can be attributed to the presence of two half bridge circuits within topology 1900, which facilitate energy transfer from the input to the output.

### Bidirectional Dual Active Three-Level DC-DC Converter

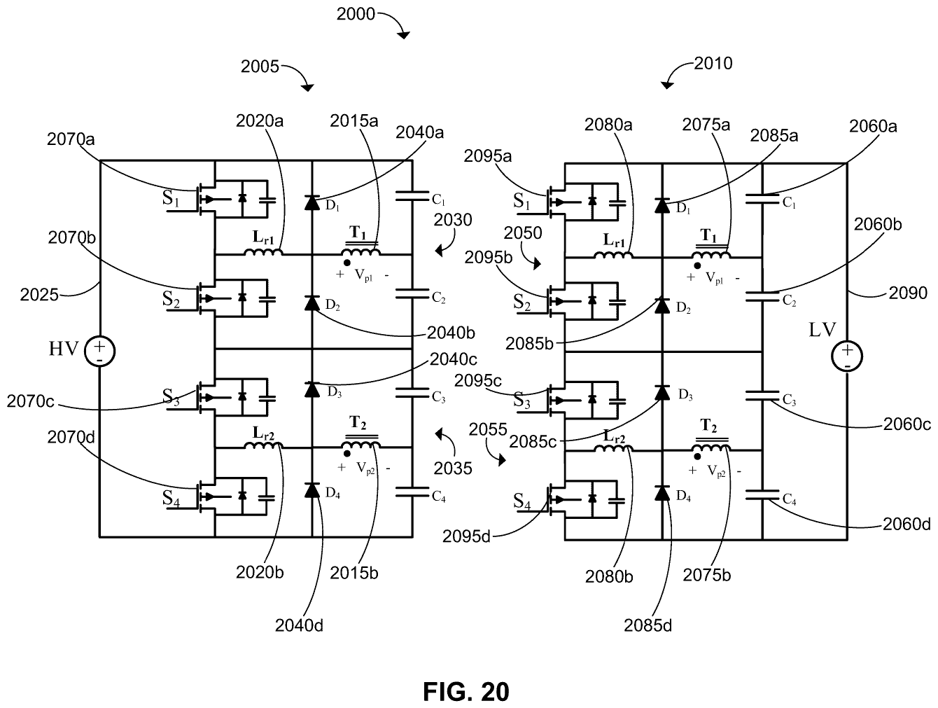

Reference is next made to FIG. 20, which illustrates a schematic view of an example DC-DC power converter topology 2000 having a primary sub-circuit 2005 and a secondary sub-circuit 2010.

Primary sub-circuit 2005 includes an input voltage HV (2025) connected to two half bridges 2030 and 2035 stacked on top of each other. Each half bridge includes an inductor (2020a, 2020b), two clamping diodes (2040a-2040d) and transformer primary winding (2015a, 2015b) in addition to the bridge switches (2070a-2070d). The inductors enable achievement of ZVS for the switches. The clamping diodes minimize any voltage ringing on the transformer primary and secondary sides.

Each half-bridge circuit 2030 and 2035 can function at full duty cycle, thereby reducing circulating current and conduction losses. This approach can enable topology 2000 to provide high efficiency during operation.

The 3L-configuration of primary sub-circuit 2005 can reduce the voltage stress across the switches of the bridge circuits to half the input voltage. Accordingly, topology 2000 can enable utilization of lower voltage rated switching devices, which offer enhanced performance and cost-effectiveness, making topology 2000 particularly suitable for high input voltage applications.

Like primary sub-circuit 2005, secondary sub-circuit 2010 also includes two half bridges (2050 and 2055) stacked on top of each other. Each half bridge includes an inductor (2080a, 2080b), two clamping diodes (2085a-2085d), output capacitors (2060a-2060d) and transformer secondary winding (2075a, 2075b) in addition to the bridge switches (2095a-2095d). The 3L-configuration of secondary sub-circuit 2010 can reduce the voltage stress across the switches of the bridge circuits to half the output voltage. Accordingly, topology 2000 can enable utilization of lower voltage rated switching devices, which offer enhanced performance and cost-effectiveness, making topology 2000 particularly suitable for high output voltage applications. Secondary sub-circuit 2010 enables bi-directional power flow between the primary and secondary sub-circuits.

A phase shift can be introduced between the bridge circuits to regulate the output voltage 2090. For topology 2000, power is transferred from primary sub-circuit 2005 to secondary sub-circuit 2010 during both the D and 1-D periods (where D is the duty cycle). This power transfer characteristic can be attributed to the presence of two half bridge circuits within topology 2000, which facilitate energy transfer from the input to the output.

### Bidirectional Dual Active Three-Level DC-DC Converter

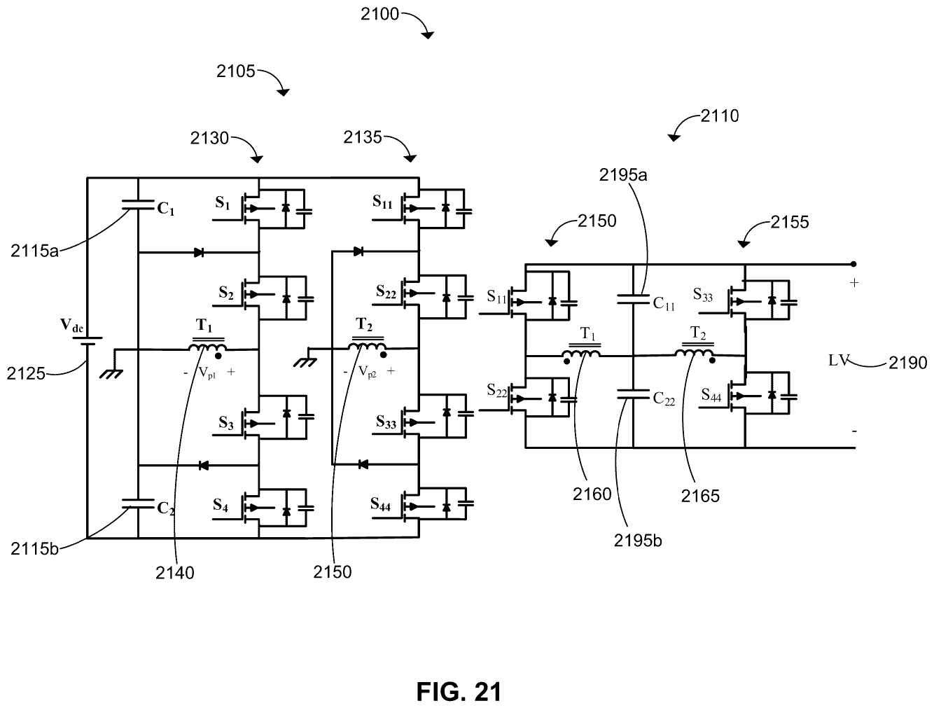

Reference is next made to FIG. 21, which illustrates a schematic view of an example DC-DC power converter topology 2100 having a primary sub-circuit 2105 and a secondary sub-circuit 2110.

Primary sub-circuit 2105 includes an input voltage Vac (2125) (applied at input capacitors 2115a, 2115b) connected to two 3-L half-bridge circuits (2130 and 2135). Each half-bridge circuit 2130 and 2135 can function at full duty cycle, thereby reducing circulating current and conduction losses. This approach can enable topology 2100 to provide high efficiency during operation.

Topology 2100 includes two transformers. The primary windings 2140 and 2150 are linked between the AC point of the corresponding half-bridge and the midpoint of the capacitors. The transformers are designed to have a low leakage inductance that can be neglected during the design process.

The 3L-configuration of primary sub-circuit 2105 can reduce the voltage stress across the switches of the bridge circuits to half the input voltage. Accordingly, topology 2100 can enable utilization of lower voltage rated switching devices, which offer enhanced performance and cost-effectiveness, making topology 2100 particularly suitable for high input voltage applications.

Secondary sub-circuit 2110 includes two half-bridge rectifiers 2150 and 2155 with active switches, each connected to the secondary windings (2160 and 2165) of the transformers. Secondary sub-circuit 2110 also includes output capacitors 2195a and 2195b. Secondary sub-circuit 2110 enables bi-directional power flow between the primary and secondary sub-circuits.

A phase shift can be introduced between the bridge circuits to regulate the output voltage 2190. For topology 2100, power is transferred from primary sub-circuit 2105 to secondary sub-circuit 2110 during both the D and 1-D periods (where D is the duty cycle). This power transfer characteristic can be attributed to the presence of two half bridge circuits within topology 2100, which facilitate energy transfer from the input to the output.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Items

Item 1: A direct current (DC)-DC power converter comprising: a primary sub-circuit coupled to a fixed or variable DC input voltage; a first secondary sub-circuit and a second secondary sub-circuit; a transformer isolating the primary sub-circuit from the first and the second secondary sub-circuits, the transformer comprising a predetermined number of turns; the first and the second secondary sub-circuits being configurable in a series mode and a parallel mode by switching configurations of a first, second and third transition switch; and the first and the second secondary sub-circuits providing an output charging voltage and an output charging current for charging an external device.

Item 2: The DC-DC power converter of any preceding item, wherein the primary sub-circuit comprises a full-bridge switching circuit, a resonant inductor, and a resonant capacitor; and each of the first and second secondary sub-circuits comprise a full-bridge switching circuit.

Item 3: The DC-DC power converter of any preceding item, wherein the primary sub-circuit comprises a 3-L neutral point clamped input voltage; and each of the first and second secondary sub-circuits comprise a full-bridge switching circuit and an inductor.

Item 4: The DC-DC power converter of any preceding item, wherein the inductor is a shim inductor.

Item 5: The DC-DC power converter of any preceding item, wherein the primary sub-circuit further comprises two flying capacitors.

Item 6: The DC-DC power converter of any preceding item, wherein the primary sub-circuit comprises a 3-L neutral point clamped input voltage, a resonant inductor and a resonant capacitor; and each of the first and second secondary sub-circuits comprise a full-bridge diode rectifier circuit.

Item 7: The DC-DC power converter of any preceding item, wherein the primary sub-circuit further comprises two flying capacitors.

Item 8: The DC-DC power converter of any preceding item, wherein the primary sub-circuit comprises a 3-L neutral point clamped input voltage, a resonant inductor and a resonant capacitor; and each of the first and second secondary sub-circuits comprise a full-bridge diode rectifier circuit.

Item 9: A direct current (DC)-DC power converter comprising: a primary sub-circuit coupled to a DC input voltage; a secondary sub-circuit comprising a first secondary sub-circuit, a second secondary sub-circuit, and an inductor, the secondary sub-circuit providing an output charging voltage and an output charging current for charging an external device; and a transformer isolating the primary sub-circuit from the secondary sub-circuit, the transformer comprising a predetermined number of turns, wherein: each of the first secondary sub-circuit and the second secondary sub-circuit comprises a 3-L inverter circuit.

Item 10: The DC-DC power converter of any preceding item, wherein the inductor is a shim inductor.

Item 11: The DC-DC power converter of any preceding item, wherein each of the first secondary sub-circuit and the second secondary sub-circuit further comprise a flying capacitor.

Item 12: A direct current (DC)-DC power converter comprising: a primary sub-circuit coupled to a DC input voltage, the primary sub-circuit comprising a 3-L neutral point clamped input voltage, a first primary sub-circuit, and a second primary sub-circuit, each of the first primary sub-circuit and the second primary sub-circuit comprising a 3-L inverter circuit; a secondary sub-circuit comprising a first secondary sub-circuit and a second secondary sub-circuit, the secondary sub-circuit providing an output charging voltage and an output charging current for charging an external device; and a transformer isolating the primary sub-circuit from the secondary sub-circuit, the transformer comprising a predetermined number of turns, wherein each of the first secondary sub-circuit and the second secondary sub-circuit comprises a 3-L inverter circuit.

Item 13: The DC-DC power converter of item 12, wherein the secondary sub-circuit further comprises an inductor.

Item 14: The DC-DC power converter of item 13, wherein the inductor is a shim inductor.

Item 15: The DC-DC power converter of item 13, wherein each of the first primary sub-circuit and the second primary sub-circuit further comprise a flying capacitor.

Item 16: The DC-DC power converter of item 13, wherein each of the first secondary sub-circuit and the second secondary sub-circuit further comprise a flying capacitor.

Item 17: The DC-DC power converter of item 12, wherein the secondary sub-circuit further comprises a resonant inductor and a resonant capacitor.

Item 18: The DC-DC power converter of item 17, wherein each of the first primary sub-circuit and the second primary sub-circuit further comprise a flying capacitor.

Item 19: The DC-DC power converter of item 17, wherein each of the first secondary sub-circuit and the second secondary sub-circuit further comprise a flying capacitor.

Item 20: The DC-DC power converter of any preceding item, wherein the external device is an electric vehicle.

We claim:

1. A direct current (DC)-DC power converter comprising:
a primary sub-circuit coupled to a fixed or variable DC input voltage;
a first secondary sub-circuit and a second secondary sub-circuit;
a transformer isolating the primary sub-circuit from the first and the second secondary sub-circuits, the transformer comprising a predetermined number of turns;
the first and the second secondary sub-circuits being configurable in a series mode and a parallel mode by switching configurations of a first, second and third transition switch; and
the first and the second secondary sub-circuits providing an output charging voltage and an output charging current for charging an external device.

2. The DC-DC power converter of claim 1, wherein the primary sub-circuit comprises a full-bridge switching circuit, a resonant inductor, and a resonant capacitor; and each of the first and second secondary sub-circuits comprise a full-bridge switching circuit.

3. The DC-DC power converter of claim 1, wherein the primary sub-circuit comprises a 3-L neutral point clamped input voltage; and each of the first and second secondary sub-circuits comprise a full-bridge switching circuit and an inductor.

4. The DC-DC power converter of claim 3, wherein the inductor is a shim inductor.

5. The DC-DC power converter of claim 3, wherein the primary sub-circuit further comprises two flying capacitors.

6. The DC-DC power converter of claim 1, wherein the primary sub-circuit comprises a 3-L neutral point clamped input voltage, a resonant inductor and a resonant capacitor; and each of the first and second secondary sub-circuits comprise a full-bridge diode rectifier circuit.

7. The DC-DC power converter of claim 6, wherein the primary sub-circuit further comprises two flying capacitors.

8. The DC-DC power converter of claim 1, wherein the primary sub-circuit comprises a 3-L neutral point clamped input voltage, a resonant inductor and a resonant capacitor; and each of the first and second secondary sub-circuits comprise a full-bridge diode rectifier circuit.

9. A direct current (DC)-DC power converter comprising:
a primary sub-circuit coupled to a DC input voltage;
a secondary sub-circuit comprising a first secondary sub-circuit, a second secondary sub-circuit, and an inductor, the secondary sub-circuit providing an output charging voltage and an output charging current for charging an external device; and
a transformer isolating the primary sub-circuit from the secondary sub-circuit, the transformer comprising a predetermined number of turns, wherein:
each of the first secondary sub-circuit and the second secondary sub-circuit comprises a 3-L inverter circuit.

10. The DC-DC power converter of claim 9, wherein the inductor is a shim inductor.

11. The DC-DC power converter of claim 9, wherein each of the first secondary sub-circuit and the second secondary sub-circuit further comprise a flying capacitor.

12. A direct current (DC)-DC power converter comprising:
a primary sub-circuit coupled to a DC input voltage, the primary sub-circuit comprising a 3-L neutral point clamped input voltage, a first primary sub-circuit, and a second primary sub-circuit, each of the first primary sub-circuit and the second primary sub-circuit comprising a 3-L inverter circuit;
a secondary sub-circuit comprising a first secondary sub-circuit and a second secondary sub-circuit, the secondary sub-circuit providing an output charging voltage and an output charging current for charging an external device; and
a transformer isolating the primary sub-circuit from the secondary sub-circuit, the transformer comprising a predetermined number of turns, wherein:
each of the first secondary sub-circuit and the second secondary sub-circuit comprises a 3-L inverter circuit.

13. The DC-DC power converter of claim 12, wherein the secondary sub-circuit further comprises an inductor.

14. The DC-DC power converter of claim 13, wherein the inductor is a shim inductor.

15. The DC-DC power converter of claim 13, wherein each of the first primary sub-circuit and the second primary sub-circuit further comprise a flying capacitor.

16. The DC-DC power converter of claim 13, wherein each of the first secondary sub-circuit and the second secondary sub-circuit further comprise a flying capacitor.

17. The DC-DC power converter of claim 12, wherein the secondary sub-circuit further comprises a resonant inductor and a resonant capacitor.

18. The DC-DC power converter of claim 17, wherein each of the first primary sub-circuit and the second primary sub-circuit further comprise a flying capacitor.

19. The DC-DC power converter of claim 17, wherein each of the first secondary sub-circuit and the second secondary sub-circuit further comprise a flying capacitor.

20. The DC-DC power converter of claim 12, wherein the external device is an electric vehicle.
